(19) United States
(12) Patent Application Publication
(10) Pub. No.: US 2006/0290829 A1
(43) Pub. Date: Dec. 28, 2006

(54) Liquid crystal display and thin film transistor array panel therefor

(76) Inventor: Dong-Gyu Kim, Gyeonggi-do (KR)

Correspondence Address: MACPHERSON KWOK CHEN & HEID LLP, 2033 GATEWAY PLACE, SUITE 400, SAN JOSE, CA, 95110, US

(21) Appl. No.: 10/550,899

(22) PCT Filed: Mar. 27, 2004
(86) PCT No.: PCT/KR04/00702

§ 371 Date: Sep. 27, 2005

(30) Foreign Application Priority Data
Mar. 28, 2003 (KR) 10-2003-0019613

(51) Int. Cl. G02F 1/136

(52) U.S. Cl. 349/44

(57) ABSTRACT

A thin film transistor array panel is provided, which includes: a gate line, a gate insulating layer and a semiconductor layer sequentially on a substrate; a data line formed on the gate insulating layer and including a source electrode; a drain electrode formed at least in part on the semiconductor layer; a color filter formed on the data line and the drain electrode and having a first opening exposing the drain electrode at least in part; a light blocking layer formed on the color filter; a passivation layer formed on the color filter and the light blocking layer and having a contact hole exposing the drain electrode through the first opening of the color filter; a pixel electrode formed on the passivation layer and contacting the drain electrode through the contact hole; and a spacer formed on the passivation layer and disposed opposite the light blocking layer.

### TECHNICAL FIELD

The present invention relates to a thin film transistor array panel and a manufacturing method thereof.

### BACKGROUND ART

Liquid crystal displays (LCDs) are one of the most widely used flat panel displays. An LCD includes two panels provided with field-generating electrodes and a liquid crystal (LC) layer interposed therebetween. The LCD displays images by applying voltages to the field-generating electrodes to generate an electric field in the LC layer, which determines orientations of LC molecules in the LC layer to adjust polarization of incident light.

Among LCDs including field-generating electrodes on respective panels, a kind of LCDs provides a plurality of pixel electrodes arranged in a matrix at one panel and a common electrode covering an entire surface of the other panel. The image display of the LCD is accomplished by applying individual voltages to the respective pixel electrodes. For the application of the individual voltages, a plurality of three-terminal thin film transistors (TFTs) are connected to the respective pixel electrodes, and a plurality of gate lines transmitting signals for controlling the TFTs and a plurality of data lines transmitting voltages to be applied to the pixel electrodes are provided on the panel.

The panels for an LCD have layered structures including several conductive layers and several insulating layers. On one panel, the gate lines, the data lines, and the pixel electrodes as well as the TFTs are made from different conductive layers preferably deposited in sequence and separated by insulating layers. On the other panel, the common electrode, color filters, and a black matrix are provided. The layers are patterned by photolithography using photo masks and by etching.

### DISCLOSURE OF THE INVENTION

### Technical Problem

The number of these steps is required to be decreased to reduce the manufacturing cost and to simplify the manufacturing process. The aperture ratio is required to be increased for higher luminance.

### Technical Solution

A thin film transistor array panel is provided, which includes: a gate line formed on an insulating substrate including a gate electrode; a gate insulating layer on the gate line; a semiconductor layer on the gate insulating layer; a data line formed on the gate insulating layer and including a source electrode; a drain electrode formed at least in part on the semiconductor layer; a color filter formed on the data line and the drain electrode and having a first opening exposing the drain electrode at least in part; a light blocking layer formed on the color filter; a passivation layer formed on the color filter and the light blocking layer and having a contact hole exposing the drain electrode through the first opening of the color filter; a pixel electrode formed on the passivation layer and contacting the drain electrode through the contact hole; and a spacer formed on the passivation layer and disposed opposite the light blocking layer.

The light blocking layer may include organic material including black pigment and the spacer may include organic material.

The thin film transistor array panel may further include a storage electrode formed under the gate insulating layer and overlapping the pixel electrode.

The thin film transistor array panel may further include a storage conductor formed on the gate insulating layer, overlapping the gate line or the storage electrode, and electrically connected to the pixel electrode.

The color filter may have a second opening exposing the storage conductor at least in part and the passivation layer further has a second contact hole exposing the storage conductor at least in part through the second opening for connection between the storage conductor and the pixel electrode.

The passivation layer may include acrylic material or a chemical vapor deposition film having a dielectric constant smaller than 4.0.

The semiconductor layer may have substantially the same planar shape as the data lines and the drain electrodes except for a portion between the source electrode and the drain electrode.

A liquid crystal display is provided, which includes: a first panel including a gate line, a data line, a thin film transistor connected to the gate line and the data line, a pixel electrode connected to the thin film transistor, and a light blocking layer including organic material and black pigment; a second panel facing the first panel and including a common electrode; and a spacer disposed between the first panel and the second panel to form a gap therebetween and overlapping the light blocking layer.

The liquid crystal display may further include a color filter formed on the first panel and having an opening exposing the drain electrode at least in part.

The liquid crystal display may further include a protrusion formed on at least one of the first and the second panels, having a height smaller than the spacer, and having a slanted lateral surface.

### Advantageous Effects

There is no need to consider the alignment between the panels and the width of the light blocking layer, the gate lines, and the data lines can be optimized to increase the aperture ratio.

### DESCRIPTION OF DRAWINGS

The present invention will become more apparent by describing embodiments thereof in detail with reference to the accompanying drawings in which:

FIG. 1 is a layout view of an exemplary TFT array panel for an LCD according to an embodiment of the present invention;

FIG. 2 is a sectional view of the TFT array panel shown in FIG. 2 taken along the line II-II′;

FIGS. 3A, 4A, SA, 6A, 7A and 8A are layout views of the TFT array panel shown in FIGS. 1 and 2 in intermediate steps of a manufacturing method thereof according to an embodiment of the present invention;

FIGS. 3A, 4B, 5B, 6B, 7B and 8B are sectional views of the TFT array panel shown in FIGS. 3A, 4A, 5A, 6A, 7A and 8A taken along the lines IIIB-IIIB′, IVB-VIB′, VB-VB′, VIB-VIB′, VIIB-VIIB′ and VIIIB-VIIIB′, respectively;

FIG. 9 is a layout view of LCD according to an embodiment of the present invention;

FIGS. 10 and 11 are sectional views of the LCD shown in FIG. 9 taken along the line X-X′ and the line XI-XI′, respectively;

FIG. 12A is a layout view of a TFT array panel shown in FIGS. 9-11 in the first step of a manufacturing method thereof according to an embodiment of the present invention;

FIGS. 12B and 12C are sectional views of the TFT array panel shown in FIG. 12A taken along the lines XIIB-XIIB′ and XIIC-XIIC′, respectively;

FIGS. 13A and 13B are sectional views of the TFT array panel shown in FIG. 12A taken along the lines XIIB-XIIB′ and XIIC-XIIC′, respectively, illustrate the step following the step shown in FIGS. 12B and 12C;

FIG. 14A is a layout view of the TFT array panel in the step following the step shown in FIGS. 13A and 13B;

FIGS. 14B and 14C are sectional views of the TFT array panel shown in FIG. 14A taken along the lines XIVB-XIVB′ and XIVC-XIVC′, respectively;

FIGS. 15A, 16A and 17A and FIGS. 15B, 16B and 17B are respective sectional views of the TFF array panel shown in FIG. 14A taken along the lines XIVB-XIVB′ and XIVC-XIVC′, respectively, and illustrate the steps following the step shown in FIGS. 14B and 14C;

FIG. 18A is a layout view of a TFT array panel in the step following the step shown in FIGS. 17A and 17B;

FIGS. 18B and 18C are sectional views of the TFT array panel shown in FIG. 19A taken along the lines XVIIIB-XVIIIB′ and XVIIIC-XVIIIC′, respectively;

FIG. 19A is a layout view of a TFT array panel in the step following the step shown in FIGS. 18A and 18B;

FIGS. 19B and 19C are sectional views of the TFT array panel shown in FIG. 19A taken along the lines XIXB-XIXB′ and XIXC-XIXC′, respectively;

FIG. 20A is a layout view of a TFT array panel in the step following the step shown in FIGS. 19A-19C;

FIGS. 20B and 20C are sectional views of the TFT array panel shown in FIG. 20A taken along the lines XXB-XXB′ and XXC-XXC′, respectively; and

FIG. 21 is a sectional view of an LCD according to another embodiment of the present invention.

### Best Mode

The present invention now will be described more fully hereinafter with reference to the accompanying drawings, in which preferred embodiments of the invention are shown. The present invention may, however, be embodied in many different forms and should not be construed as limited to the embodiments set forth herein.

In the drawings, the thickness of layers, films and regions are exaggerated for clarity. Like numerals refer to like elements throughout. It will be understood that when an element such as a layer, film, region or substrate is referred to as being ‘on’ another element, it can be directly on the other element or intervening elements may also be present. In contrast, when an element is referred to as being ‘directly on’ another element, there are no intervening elements present.

Now, LCDs, TFT array panels and manufacturing methods thereof according to embodiments of the present invention will be described with reference to the accompanying drawings.

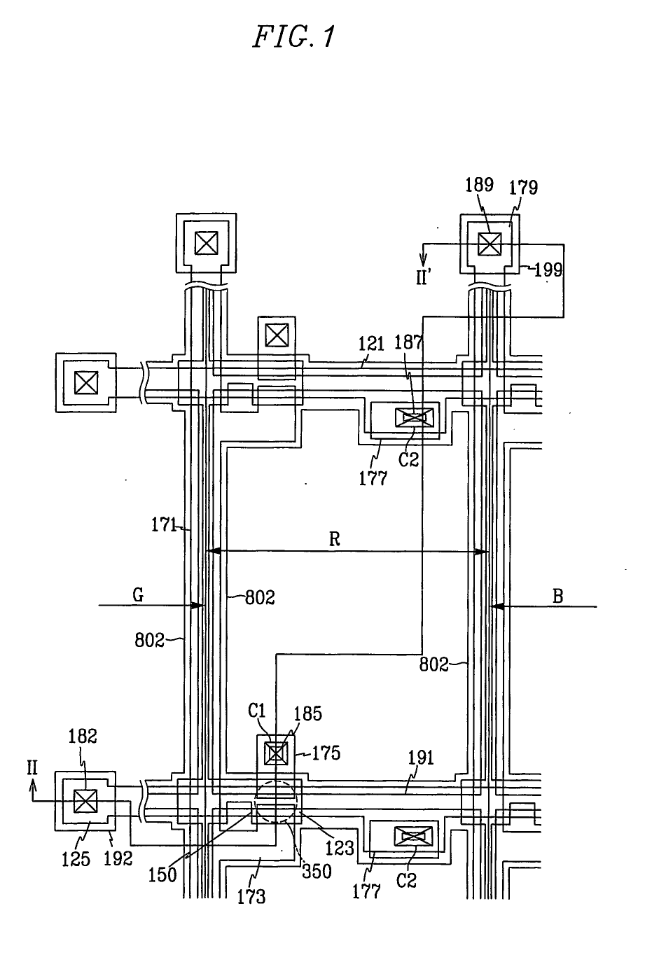

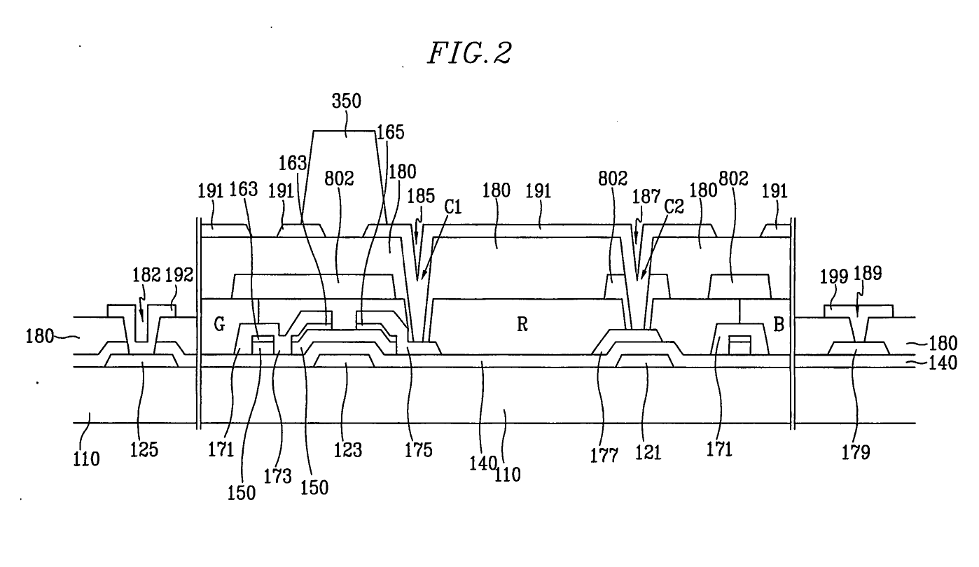

A TFT array panel for an LCD according to an embodiment of the present invention will be described in detail with reference to FIGS. 1 and 2.

FIG. 1 is a layout view of an exemplary TFT array panel for an LCD according to an embodiment of the present invention, and FIG. 2 is a sectional view of the TFT array panel shown in FIG. 2 taken along the line II-II′.

A plurality of gate lines 121 for transmitting gate signals are formed on an insulating substrate 110. Each gate line 121 extends substantially in a transverse direction and a plurality of portions of each gate line 121 form a plurality of gate electrodes 123. Each gate line 121 includes a plurality of projections protruding downward and an end portion 125 having a larger area for contact with another layer or an external device.

The gate lines 121 are preferably made of Al containing metal such as Al and Al alloy, Ag containing metal such as Ag and Ag alloy, Cu containing metal such as Cu and Cu alloy, Cr, Mo, Mo alloy, Ta, or Ti. The gate lines 121 may have a multilayered structure including at least two films having different physical characteristics, a lower film and an upper film. The upper film is preferably made of low resistivity metal such as Al containing metal, Ag containing metal, and Cu containing metal for reducing signal delay or voltage drop in the gate lines 121. On the other hand, the lower film is preferably made of material such as Cr, Mo, Mo alloy, Ta and Ti, which has good physical, chemical, and electrical contact characteristics with other materials such as indium tin oxide (ITO) and indium zinc oxide (IZO). A good exemplary combination of the lower film material and the upper film material is Cr and Al—Nd alloy.

The lateral sides of the upper film and the lower film are inclined relative to a surface of the substrate 110, and the inclination angle thereof ranges about 30-80 degrees.

A gate insulating layer 140 preferably made of silicon nitride (SiNx) is formed on the gate lines 121.

A plurality of semiconductor stripes 150 preferably made of hydrogenated amorphous silicon (abbreviated to ‘a-Si’) or polysilicon are formed on the gate insulating layer 140. Each semiconductor stripe 150 extends substantially in a longitudinal direction and has a plurality of projections branched out toward the gate electrodes 123. The width of each semiconductor stripe 150 becomes large near the gate lines 121 such that the semiconductor stripe 150 covers large areas of the gate lines 121.

A plurality of ohmic contact stripes and islands 163 and 165 preferably made of silicide or n+ hydrogenated a-Si heavily doped with n type impurity are formed on the semiconductor stripes 150. Each ohmic contact stripe 163 has a plurality of projections, and the projections and the ohmic contact islands 165 are located in pairs on the projections of the semiconductor stripes 150.

The lateral sides of the semiconductor stripes 150 and the ohmic contacts 163 and 165 are inclined relative to the surface of the substrate 110, and the inclination angles thereof are preferably in a range between about 30-80 degrees.

A plurality of data lines 171, a plurality of drain electrodes 175, and a plurality of storage capacitor conductors 177 are formed on the ohmic contacts 163 and 165 and the gate insulating layer 140.

The data lines 171 for transmitting data voltages extend substantially in the longitudinal direction and intersect the gate lines 121. A plurality of branches of each data line 171, which project toward the drain electrodes 175, form a plurality of source electrodes 173. Each pair of the source electrodes 173 and the drain electrodes 175 are separated from each other and opposite each other with respect to a gate electrode 123. A gate electrode 123, a source electrode 173, and a drain electrode 175 along with a projection of a semiconductor stripe 150 form a TFT having a channel formed in the projection disposed between the source electrode 173 and the drain electrode 175.

The storage capacitor conductors 177 overlap the projections of the gate lines 121.

The data lines 171, the drain electrodes 175, and the storage capacitor conductors 177 include a film preferably made of refractory metal such as Mo, Mo alloy, Cr, Ta and Ti. They may further include an additional film located thereon and preferably made of Al containing metal. Each data line 171 includes an end portion 179 having a large are for contact with another layer or an external device.

Like the gate lines 121, the data lines 171, the drain electrodes 175, and the storage capacitor conductors 177 have inclined lateral sides, and the inclination angles thereof range about 30-80 degrees.

The ohmic contacts 163 and 165 are interposed only between the underlying semiconductor stripes 150 and the overlying data lines 171 and the overlying drain electrodes 175 thereon and reduce the contact resistance therebetween. The semiconductor stripes 150 include a plurality of exposed portions, which are not covered with the data lines 171 and the drain electrodes 175, such as portions located between the source electrodes 173 and the drain electrodes 175. Although the semiconductor stripes 150 are narrower than the data lines 171 at most places, the width of the semiconductor stripes 150 becomes large near the gate lines as described above, to smooth profile of the surface, thereby preventing the disconnection of the data lines 171.

A plurality of red, green, and blue color filters R, G and B are formed on the data lines 171, the drain electrodes 175, the storage conductors 177, and the exposed portions of the semiconductor stripes 150. The color filters R, G and B are disposed between adjacent data lines 171 and extend in the longitudinal direction. Although the figures show that edges of adjacent color filters R, G and B coincide with each other, the adjacent color filters R, G and B may overlap each other near their edges to block light leakage or on the contrary, they may be spaced apart from each other to expose the data lines 171. In the formal case, the overlapping of the color filters R, G and B may make a hill that can serve as a protrusion for controlling tilt directions of liquid crystal molecules. The color filters R, G and B have a plurality of openings C1 and C2 disposed on the drain electrodes 175 and the storage capacitor conductors 177. There is no color filter on peripheral areas provided with the end portions 125 and 179 of the gate lines 121 and the data lines 171. However, at least one of the color filters R, G and B may be provided on the peripheral area and, in this case, it may have a plurality of openings disposed on the end portions 125 and 179 if the gate lines 121 and the data lines 171.

An interlayer insulating layer (not shown) preferably made of silicon oxide and silicon nitride may be disposed under the color filters R, G and B.

A light blocking layer 802 called a black matrix is formed on the color filters R, G and B opposite the gate lines 121 and the data lines 171. The light blocking layer 802 blocks the light leakage near the gate lines 121 and the data lines 171 as well as the light incident on the channels of the TFTs and the light incident on and reflected by the data lines 171 and the gate lines 121. It is preferable that the light blocking layer 802 entirely covers the data lines 171 and the gate lines 121. The light blocking layer 802 is preferably made of organic material including black pigment and it may include portions disposed on the peripheral areas.

A passivation layer 180 is formed on the light blocking layer 802 and the color filters R, G and B. The passivation layer 180 is preferably made of acrylic organic material having a good flatness characteristic and low resistivity or low dielectric insulating material having dielectric constant lower than 4.0 such as a-Si:C:O and a-Si:O:F formed by plasma enhanced chemical vapor deposition (PECVD).

The passivation layer 180 has a plurality of contact holes 185 and 189 exposing the drain electrodes 175, and the end portions 179 of the data lines 171, respectively. The passivation layer 180 and the light blocking layer 802 have a plurality of contact holes 187 exposing the storage capacitor conductors 177, and the passivation layer 180 and the gate insulating layer 140 have a plurality of contact holes 182 exposing the end portions 125 of the gate lines 121. The contact holes 185 and 187 pass through the openings C1 and C2 of the color filters R, G and B such that the contact holes 185 and 187 are enclosed by the openings C1 and C2 in the layout view. When the light blocking layer 802 is also provided on the peripheral area, the contact holes 182 and 189 also penetrate the light blocking layer 802. When the interlayer insulating layer is provided, the contact holes 182, 185, 187 and 189 also penetrate the interlayer insulating layer.

Sidewalls of the contact holes 182, 185, 187 and 189 and the openings C1 and C2 are inclined relative to bottom surfaces of the contact holes 182, 185, 187 and 189 and their slope may be different. It is preferable that upper or inner sidewalls are smoother than lower or outer sidewalls and the slope thereof ranges about 140-180 degrees.

The size of the contact holes 185 and 187 may be larger than the openings C1 and C2 to expose top surfaces of the color filters R, G and B such that the slope has a step for smoothing the profile of an overlying layer.

A plurality of pixel electrodes 191 and a plurality of contact assistants 192 and 199, which are preferably made of ITO or IZO, are formed on the passivation layer 180.

The pixel electrodes 191 are physically and electrically connected to the drain electrodes 175 through the contact holes 185 and to the storage capacitor conductors 177 through the contact holes 187 such that the pixel electrodes 191 receive the data voltages from the drain electrodes 175 and transmit the received data voltages to the storage capacitor conductors 177.

The pixel electrodes 191 supplied with the data voltages generate electric fields in cooperation with a common electrode (not shown) on the other panel (not shown), which reorient liquid crystal molecules in a liquid crystal layer (not shown) disposed therebetween.

A pixel electrode 191 and a common electrode 270 form a liquid crystal capacitor, which stores applied voltages after turn-off of the TFT. An additional capacitor called a ‘storage capacitor,’ which is connected in parallel to the liquid crystal capacitor, is provided for enhancing the voltage storing capacity. The storage capacitors are implemented by overlapping the pixel electrodes 191 with the gate lines 121 adjacent thereto (called ‘previous gate lines’). The capacitances of the storage capacitors, i.e., the storage capacitances are increased by providing the projections at the gate lines 121 for increasing overlapping areas and by providing the storage capacitor conductors 177, which are connected to the pixel electrodes 191 and overlap the projections, under the pixel electrodes 191 for decreasing the distance between the terminals.

The liquid crystal layer may have positive dielectric anisotropy and be homogeneously aligned. Alternatively, the liquid crystal layer may have negative dielectric anisotropy and be homeotropically aligned. In this case, the pixel electrodes 191 may have a plurality of cutouts that generate horizontal components in the electric field to determine the tilt directions of the liquid crystal molecules.

FIG. 1 shows that the pixel electrodes 191 overlap the gate lines 121 and the data lines 171 to increase aperture ratio. However, the pixel electrodes 191 may overlap the light blocking layer 802 but not the data lines 171 to reduce the parasitic capacitance therebetween.

The contact assistants 192 and 199 are connected to the exposed end portions 125 of the gate lines 121 and the exposed end portions 179 of the data lines 171 through the contact holes 182 and 189, respectively. The contact assistants 192 and 199 are not requisites but preferred to protect the exposed portions 125 and 179 and to complement the adhesiveness of the exposed portions 125 and 179 and external devices.

A plurality of metal pieces (not shown) made of the same layer as the gate lines 121 and the data lines 171 may be provided near the end portions 125 and 179 of the gate lines 121 and the data lines 171, respectively. The metal pieces are exposed though a plurality of contact holes in the passivation layer 180 and the gate insulating layer 140 and connected to the respective contact assistants 192 and 199.

A plurality of columnar spacers 350 preferably made of organic insulating material are formed on the passivation layer 180. The spacers 350 form a gap between the TFT array panel and the other panel and they are disposed on the TFTs and on the light blocking layer 802. It is preferable that portions of the light blocking layer 802 underlying the spacers 350 are wider than the spacers 350 such that they block the light leakage generated by the spacers 350.

An alignment layer (not shown) is coated on a surface of the TFT array panel.

According to another embodiment of the present invention, the pixel electrodes 191 are made of transparent conductive polymer. For a reflective LCD, the pixel electrodes 191 are made of opaque reflective metal. In these cases, the contact assistants 192 and 199 may be made of material such as ITO or IZO different from the pixel electrodes 191.

As described above, the color filters and the light blocking layer are provided on the TFT array panel such that they are removed from the other panel. Accordingly, there is no need to consider the alignment between the panels and the width of the light blocking layer, the gate lines, and the data lines can be optimized to increase the aperture ratio.

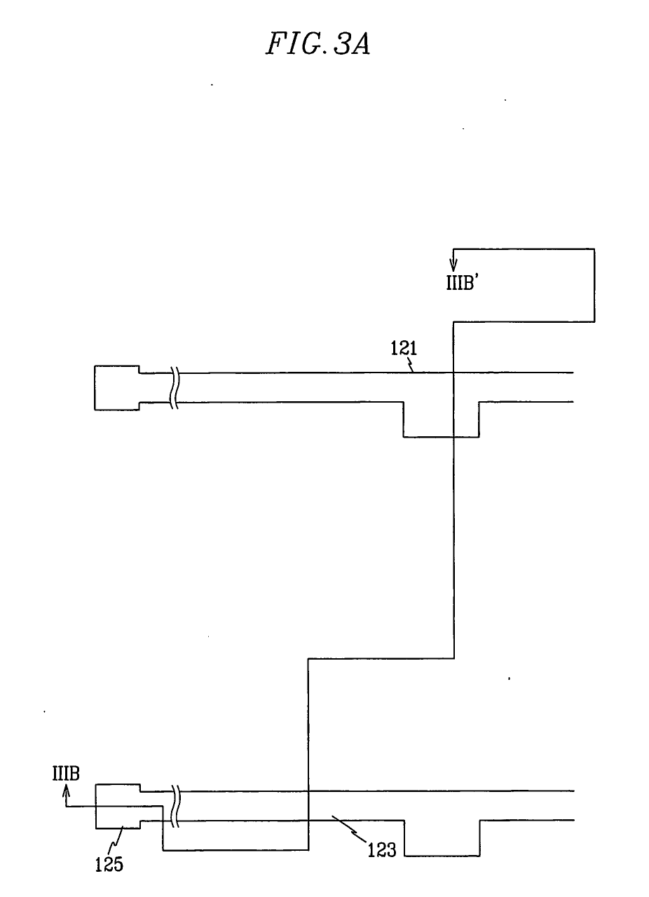

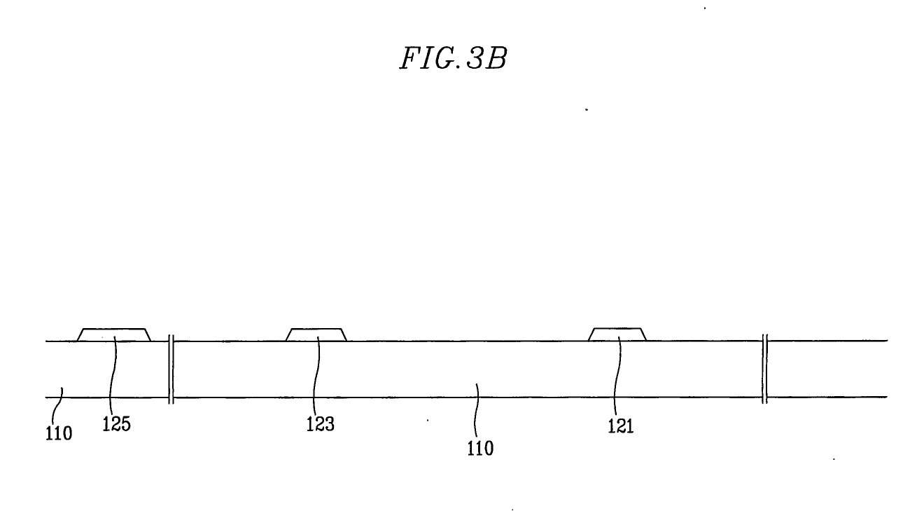

A method of manufacturing the TFT array panel shown in FIGS. 1 and 23 according to an embodiment of the present invention will be now described in detail with reference to FIGS. 3A to 8B as well as FIGS. 1 and 2.

FIGS. 3A, 4A, 5A, 6A, 7A and 8A are layout views of the TFT array panel shown in FIGS. 1 and 2 in intermediate steps of a manufacturing method thereof according to an embodiment of the present invention, and FIGS. 3A, 4B, 5B, 6B, 7B and 8B are sectional views of the TFT array panel shown in FIGS. 3A, 4A, 5A, 6A, 7A and 8A taken along the lines IIIB-IIIB′, IVB-VIB′, VB-VB′, VIB-VIB′, VIIB-VIIB′ and VIIIB-VIIIB′, respectively.

Referring to FIGS. 3A and 3B, a plurality of gate lines 121 including a plurality of gate electrodes 123 are formed by photo-etching on an insulating substrate 110.

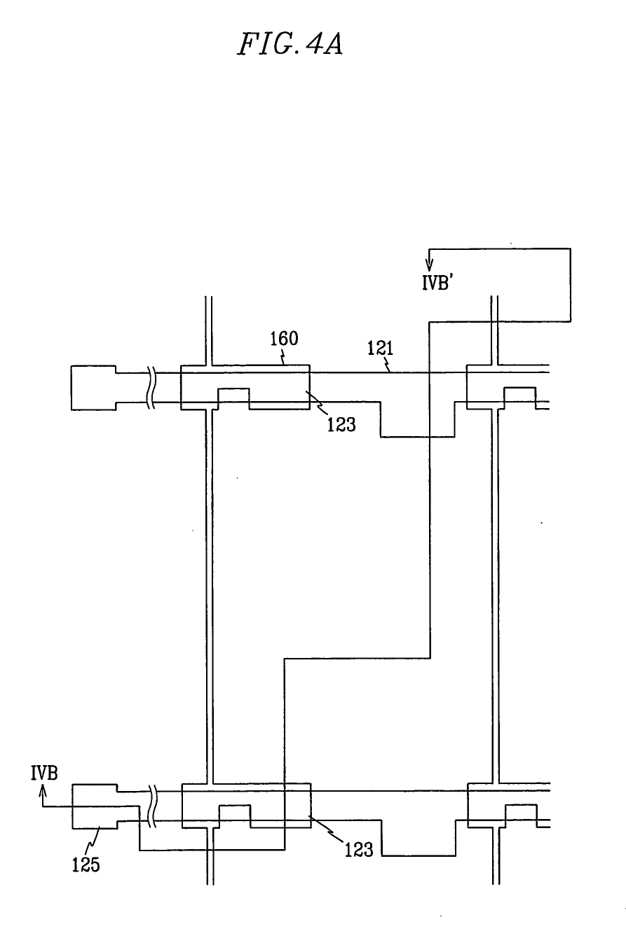

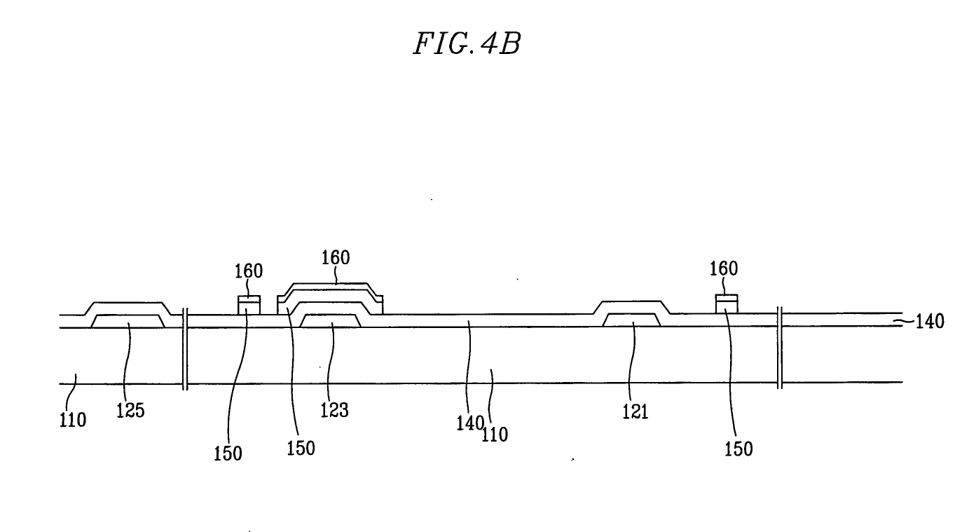

Referring to FIGS. 4A and 4B, after sequential deposition of a gate insulating layer 140, an intrinsic a-Si layer, and an extrinsic a-Si layer, the extrinsic a-Si layer and the intrinsic a-Si layer are photo-etched to form a plurality of extrinsic semiconductor stripes 160 and a plurality of intrinsic semiconductor stripes 150 on the gate insulating layer 140.

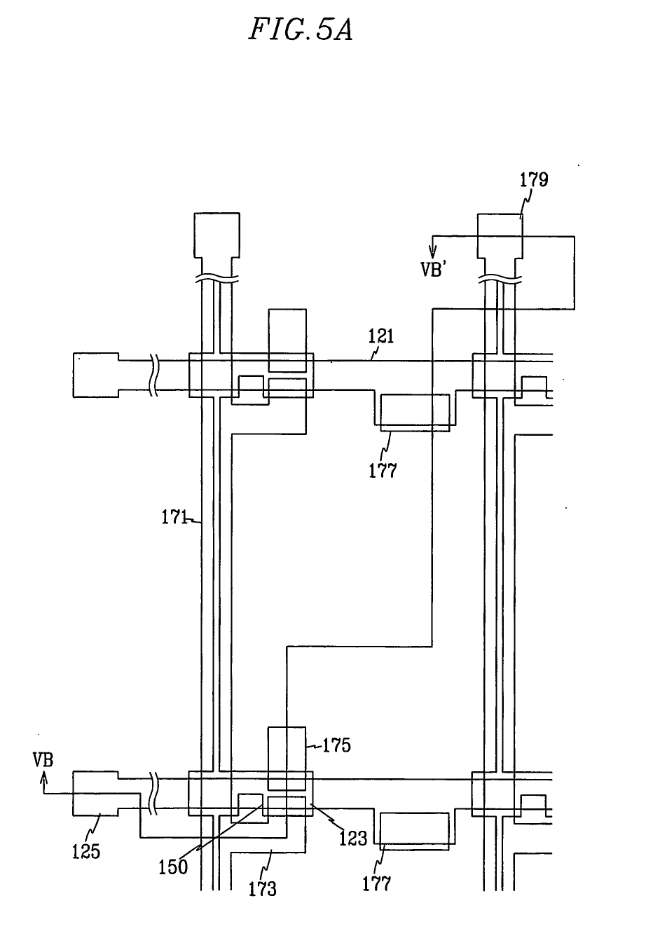

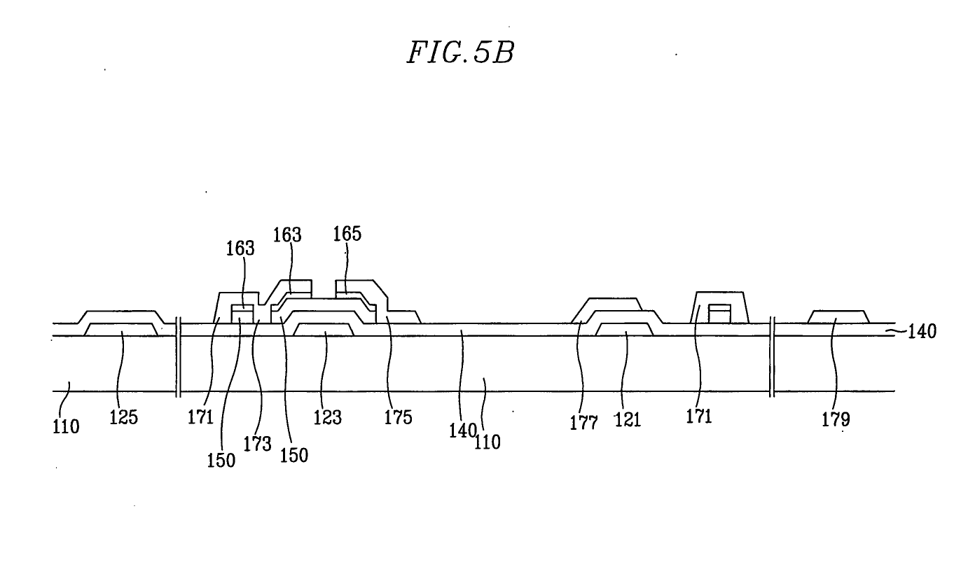

Referring to FIGS. 5A and 5B, a plurality of data lines 171 including a plurality of source electrodes 173, a plurality of drain electrodes 175, and a plurality of storage capacitor conductors 177 are formed by photo-etching.

Thereafter, portions of the extrinsic semiconductor stripes 160, which are not covered with the data lines 171, the drain electrodes 175, and the storage capacitor conductors 177, are removed to complete a plurality of ohmic contact stripes 163 and a plurality of ohmic contact islands 165 and to expose portions of the intrinsic semiconductor stripes 150. Oxygen plasma treatment preferably follows thereafter in order to stabilize the exposed surfaces of the semiconductor stripes 150.

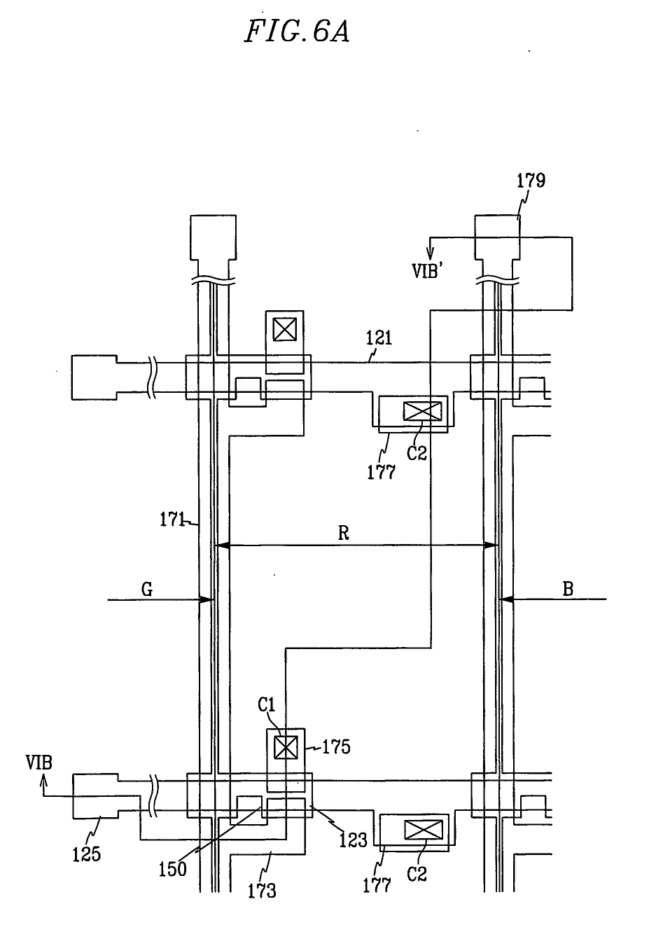

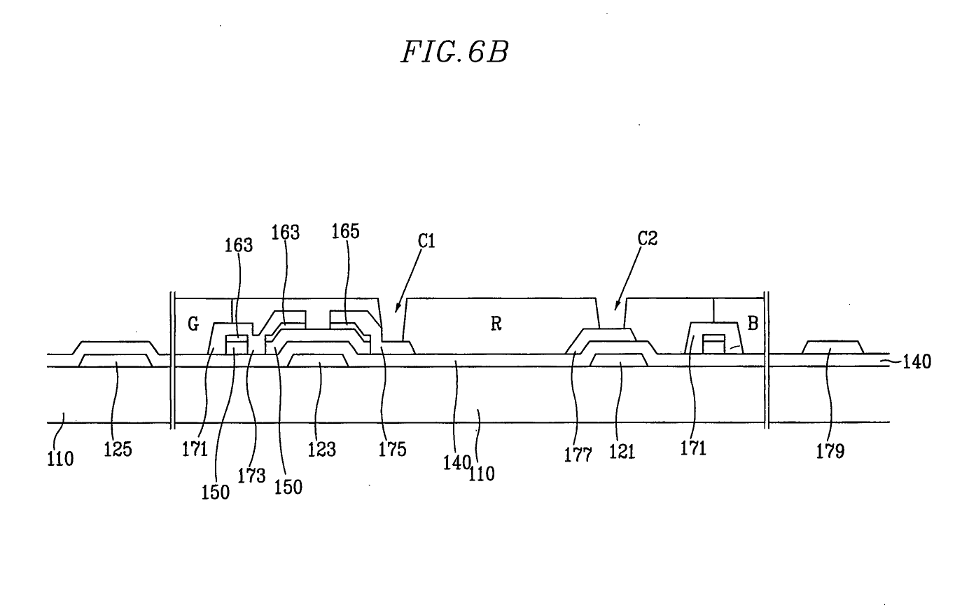

Referring to FIGS. 6A and 6B, photosensitive organic films respectively containing red, green, and blue pigments are coated and patterned by photolithography to form a plurality of color filters R, G and B having a plurality of openings C1 and C2 in a sequential manner.

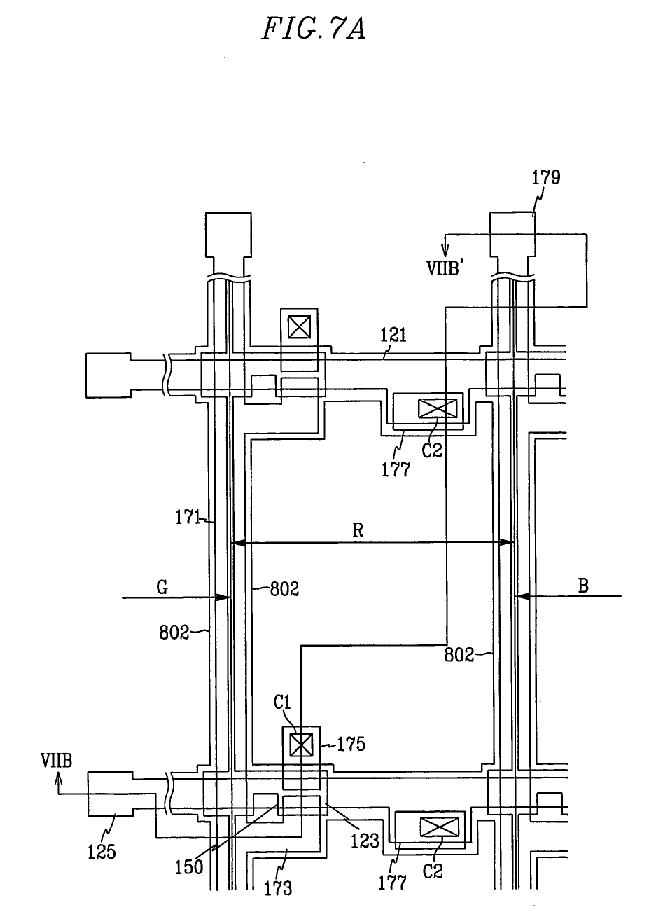

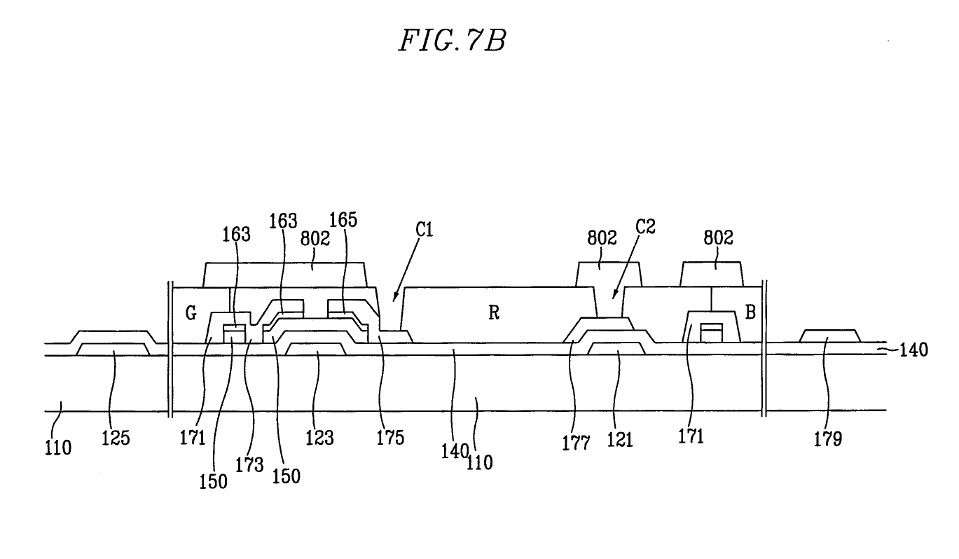

As shown in FIGS. 7A and 7B, a photosensitive organic film containing black pigment is coated and patterned by photolithography to form a light blocking layer 802.

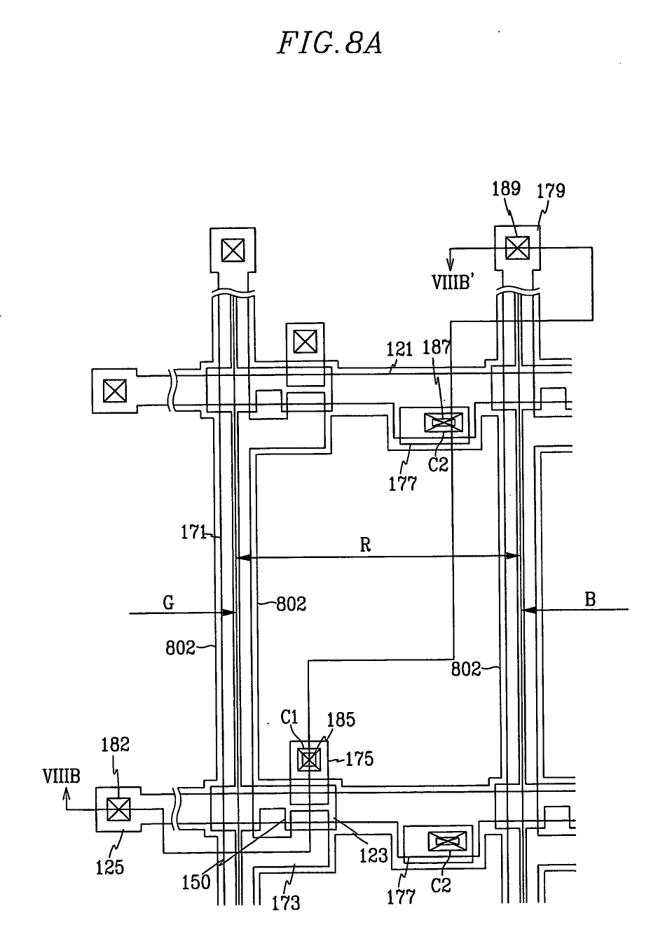

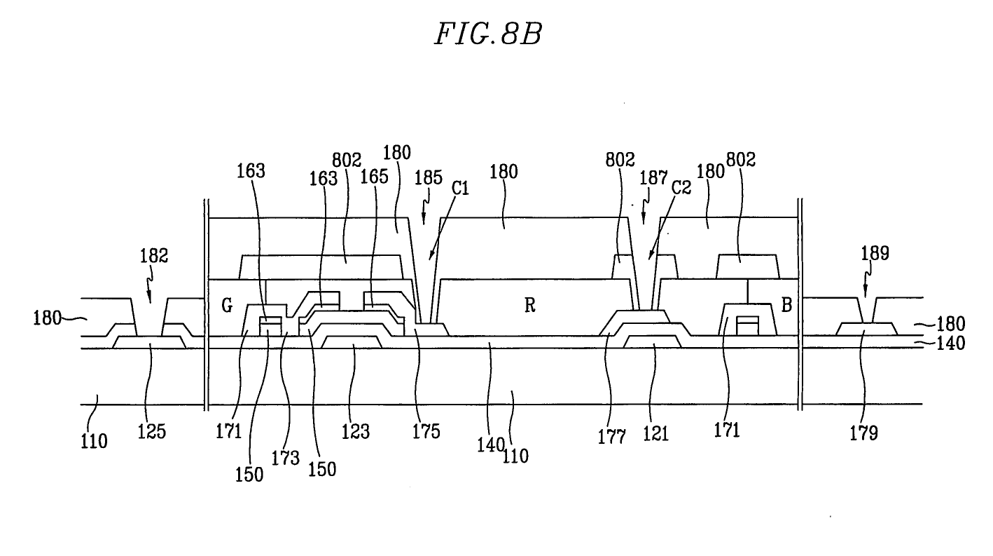

Referring to FIGS. 8A and 8B, after depositing a passivation layer 180, the passivation layer 180, the light blocking layer 802, and the gate insulating layer 140 are patterned by photo-etching to form a plurality of contact holes 182, 185, 187 and 189. A top surface of the passivation layer 180 has a uniform height such that the passivation layer 180 absorbs the steps formed by the light blocking layer 802 that may disorder orientations of the liquid crystal molecules, thereby preventing light leakage. The contact holes 182, 185, 187 and 189 have slanted sidewalls and they are surrounded by the openings C1 and C2.Referring to FIGS. 1 and 2, a plurality of pixel electrodes 191 and a plurality of contact assistants 192 and 199 are formed on the passivation layer 180 by sputtering and photo-etching an ITO or IZO layer. Since the contact holes 182, 185, 187 and 189 have smooth sidewalls, the profile of the pixel electrodes 179 and the contact assistants 192 and 199 become smooth.

Finally, an organic insulating layer is deposited and photo-etched to form a plurality of columnar spacers 350 and an alignment layer (not shown) is coated on the passivation layer 180 and the spacers 350.

The light blocking layer 802 is prevented from being damaged since following etching and cleaning processes are performed after it is covered with the passivation layer 180. The covering of the light blocking layer 802 also prevents the organic of the light blocking layer 180 from contaminating liquid crystal when the alignment layer is damaged to be stripped.

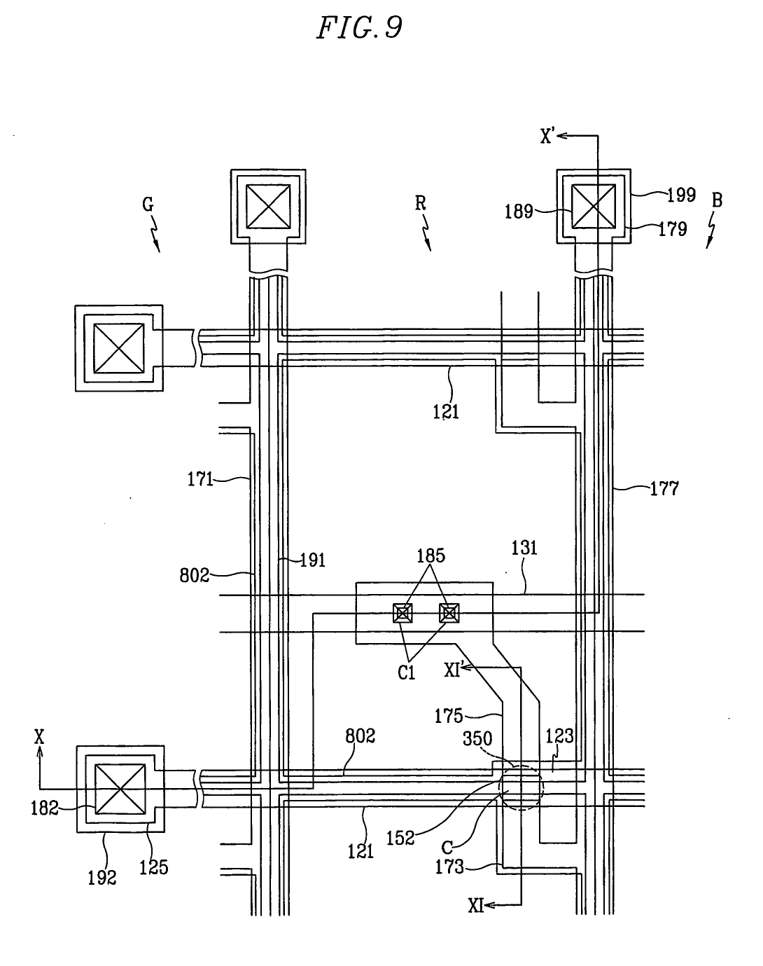

An LCD according to an embodiment of the present invention will be described in detail with reference to FIGS. 9-11.

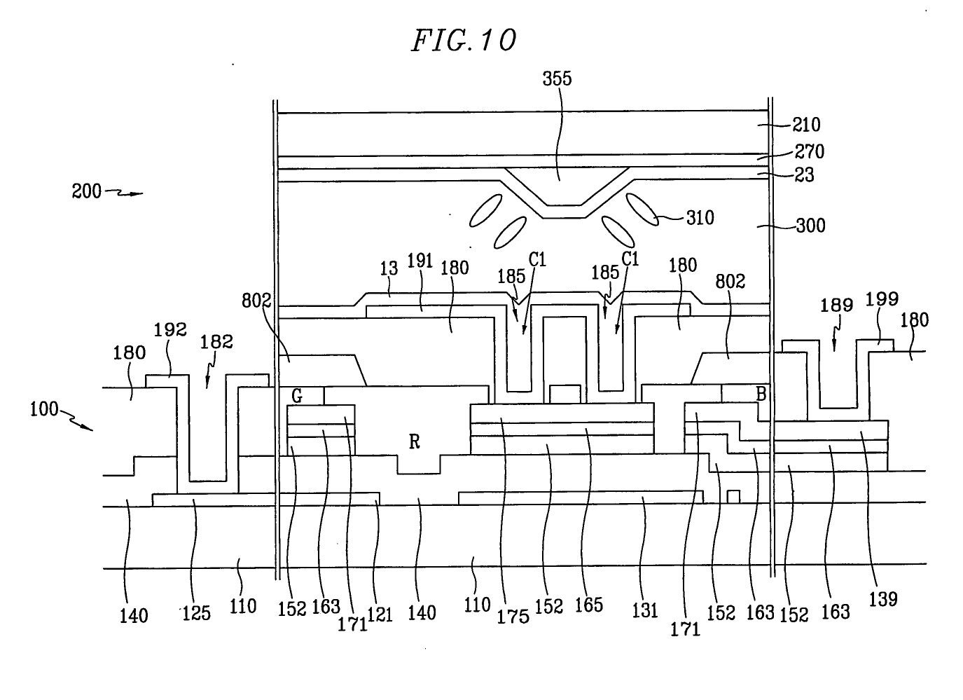

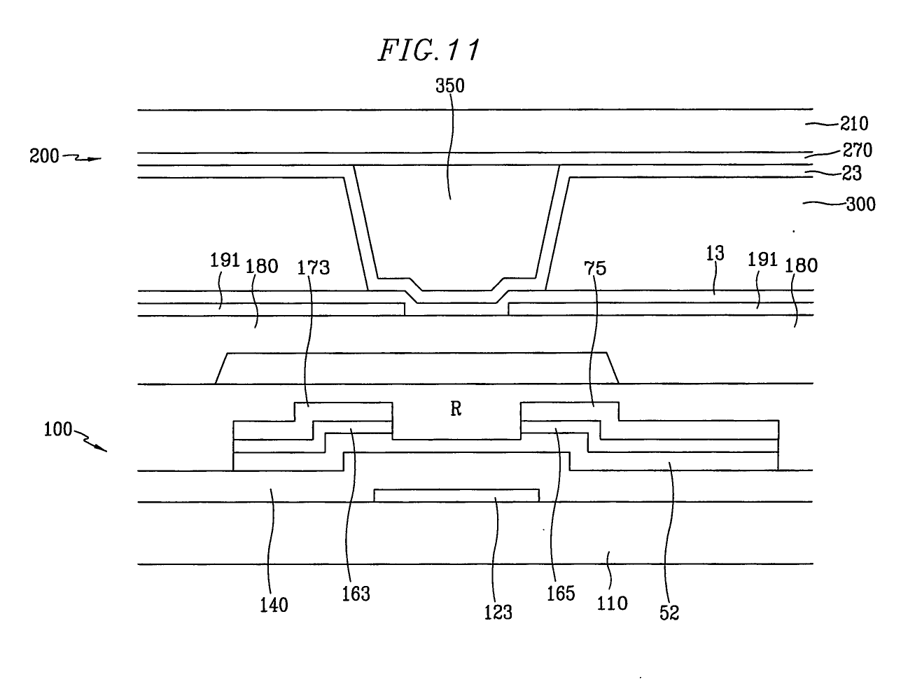

FIG. 9 is a layout view of LCD according to an embodiment of the present invention, and FIGS. 10 and 11 are sectional views of the LCD shown in FIG. 9 taken along the line X-X′ and the line XI-XI′, respectively.

As shown in FIGS. 9-11, an LCD according to this embodiment includes An LCD according to an embodiment of the present invention includes a TFT array panel 100, a common electrode panel 200 facing the TFT array panel 100, and a liquid crystal layer 300 interposed between the TFT array panel 100 and the common electrode panel 200 and containing a plurality of liquid crystal molecules 310.

A layered structure of the TFT array panel 100 according to this embodiment is almost the same as that shown in FIGS. 1 and 2. That is, a plurality of gate lines 121 including a plurality of gate electrodes 123 are formed on a substrate 110, and a gate insulating layer 140, a plurality of semiconductor stripes 152, and a plurality of ohmic contact stripes 163 and a plurality of ohmic contact islands 165 are sequentially formed thereon. A plurality of data lines 171 including a plurality of source electrodes 173 and a plurality of drain electrodes 175 are formed on the ohmic contacts 163 and 165, and a plurality of color filters R, G and B having a plurality of openings C1 and C2 are formed thereon. A light blocking layer 802 is formed on the color filters R, G and B and a passivation layer 180 is formed thereon. A plurality of contact holes 182, 185 and 189 are provided at the passivation layer 180 and the gate insulating layer 140, and a plurality of pixel electrodes 191 and a plurality of contact assistants 192 and 199 are formed on the passivation layer 180. An alignment layer 13 that is not shown in FIGS. 1 and 2 is formed on the passivation layer 180 and the pixel electrodes 191.

Different from the TFT array panel shown in FIGS. 1 and 2, the TFT array panel according to this embodiment provides a plurality of storage electrode lines 131, which are separated from the gate lines 121, on the same layer as the gate lines 121 without projections of the gate lines 121. The storage electrode lines 131 are supplied with a predetermined voltage such as the common voltage. Without providing the storage capacitor conductors 177 shown in FIGS. 1 and 2, the drain electrodes 175 extend to overlap the storage electrode lines 131 to form storage capacitors. The storage electrode lines 131 may be located near the gate lines 121 in consideration of aperture ratio. However, the storage electrode lines 131 may be omitted.

The semiconductor stripes 152 have almost the same planar shapes as the data lines 171 and the drain electrodes 175 as well as the underlying ohmic contacts 163 and 165. However, the semiconductor stripes 152 include some exposed portions, which are not covered with the data lines 171 and the drain electrodes 175, such as portions located between the source electrodes 173 and the drain electrodes 175.

Furthermore, the light blocking layer 802 is narrower than the data lines 171 and the gate lines 121 but it still entirely covers a TFT, and there is no spacer on the TFT array panel 100.

The description of the common electrode panel 200 follows.

A common electrode 270 preferably made of transparent conductive material such as ITO and IZO is formed on an insulating substrate 210 such as transparent glass. The common electrode 270 is supplied with the common voltage and it may have a plurality of cutouts (not shown). The common electrode 270 may have a plurality of cutouts.

A plurality of columnar spacers 350 and a plurality of protrusions 355 preferably made of organic insulating material are formed on the common electrode 270.

The spacers 350 form a gap between the TFT array panel 100 and the common electrode panel 200 and they face the TFTs and the light blocking layer 802 on the TFT array panel 100. It is preferable that the spacers 350 are entirely covered with the light blocking layer 802 such that they block the light leakage generated by the spacers 350.

The protrusions 355 have slanted lateral surfaces for giving pretilt to the liquid crystal molecules 310.

An alignment layer 23 is formed on the common electrode 270, the spacers 350 and the protrusions 355. The alignment layer 23 is a homeotropic alignment layer and it runs over the lateral surfaces of the protrusions 355 to align the LC molecules 310 to be oblique to a surface of the substrate 210.

A pair of polarizers (not shown) are provided on outer surfaces of the panels 100 and 200 such that their transmissive axes are crossed and one of the transmissive axes is parallel to the gate lines 121.

The LCD may further include at least one retardation film compensating the retardation of the LC layer 300 and a backlight unit for providing light for the LCD.

The LC layer 300 has negative dielectric anisotropy and the LC molecules 310 in the LC layer 300 are aligned such that their long axes are vertical to the surfaces of the alignment layer 23 in absence of electric field.

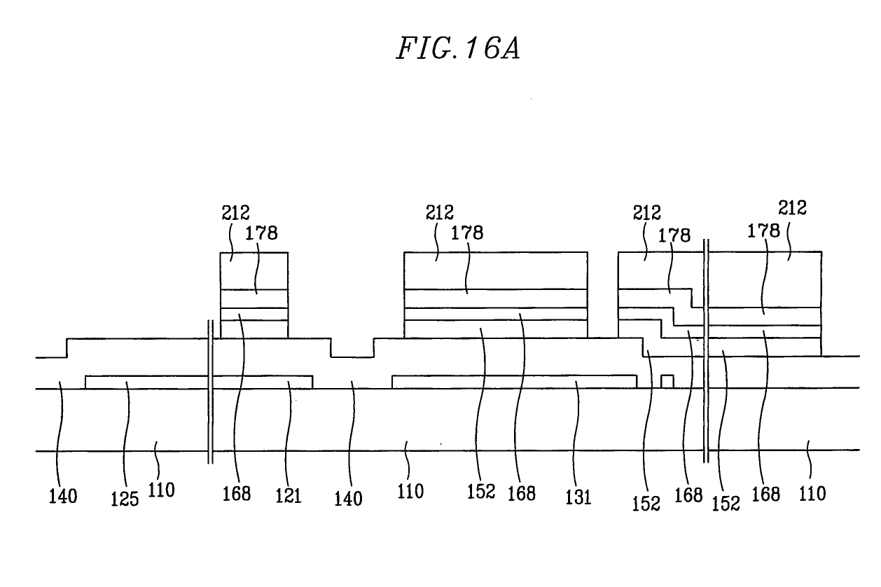

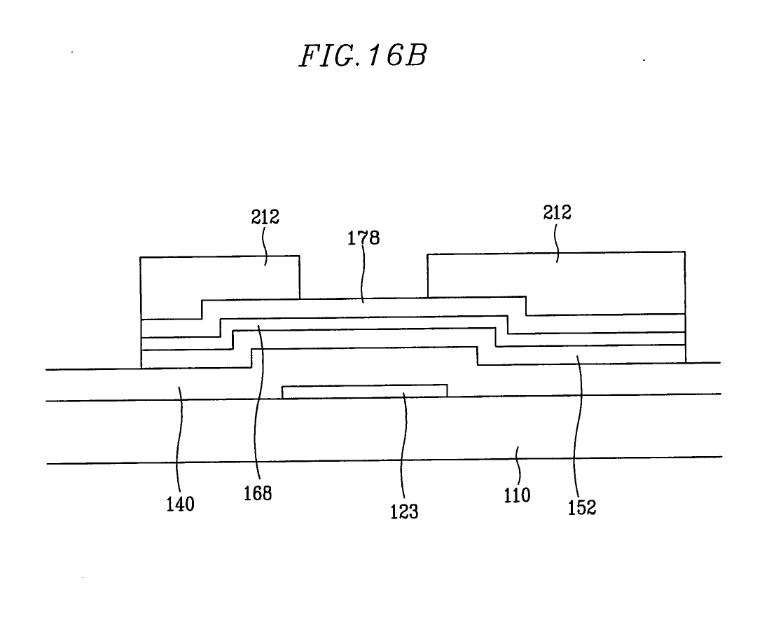

Many of the above-described features of the LCD shown in FIGS. 1-5 may be appropriate to the LCD shown in FIGS. 16-18.

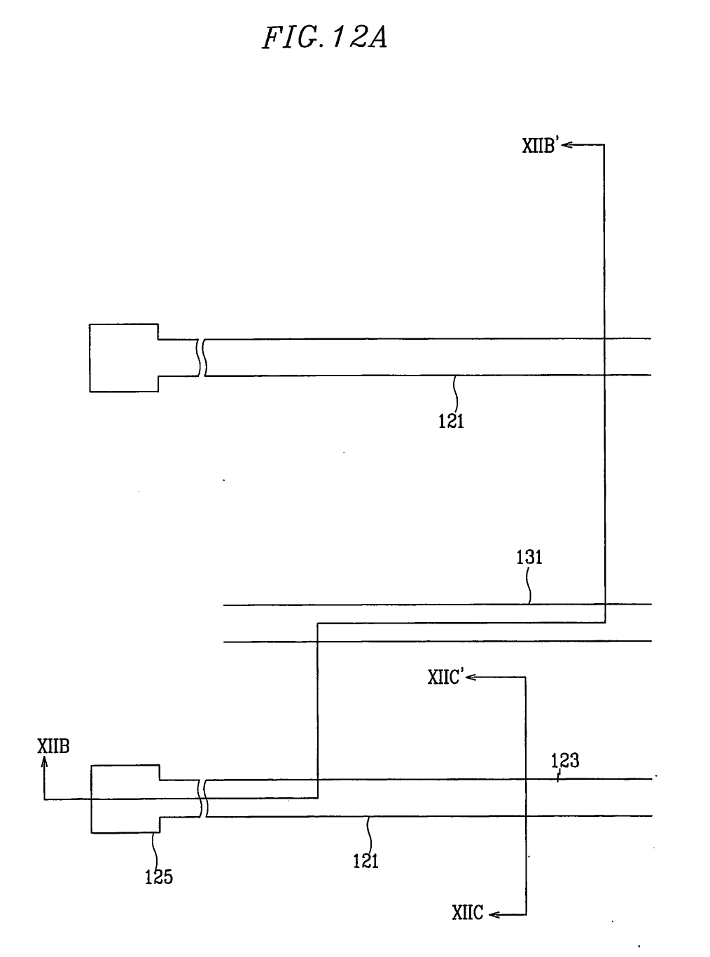

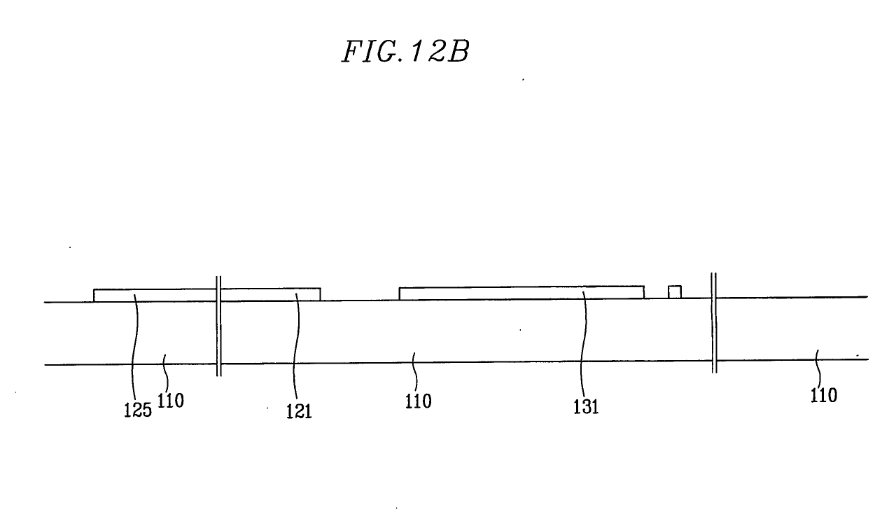

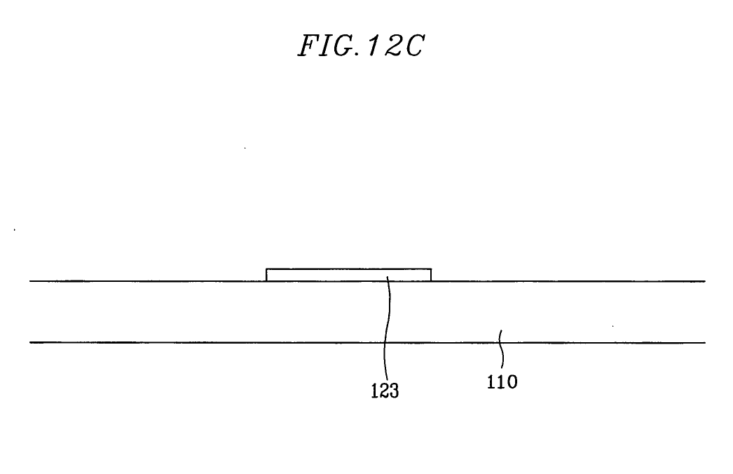

Now, a method of manufacturing the TFT array panel shown in FIGS. 9-11 according to an embodiment of the present invention will be described in detail with reference to FIGS. 12A-20C, which illustrate the manufacturing method, as well as FIGS. 9-11.

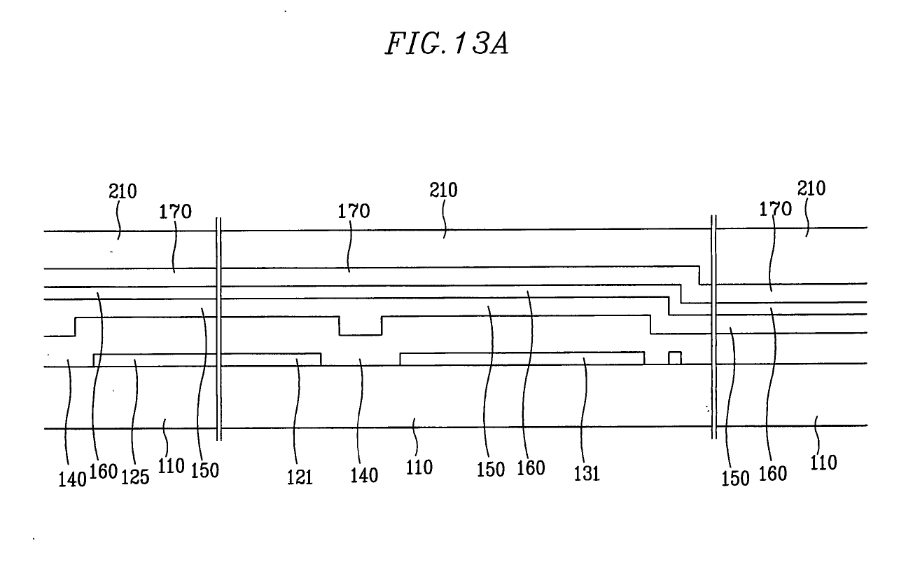

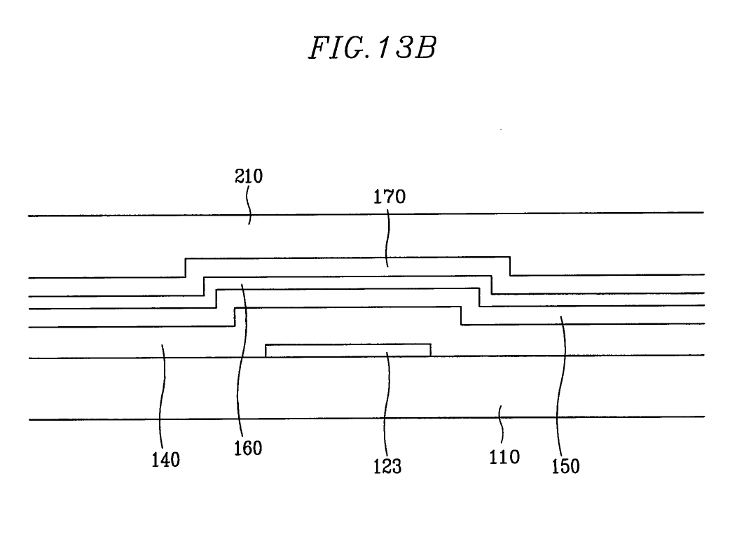

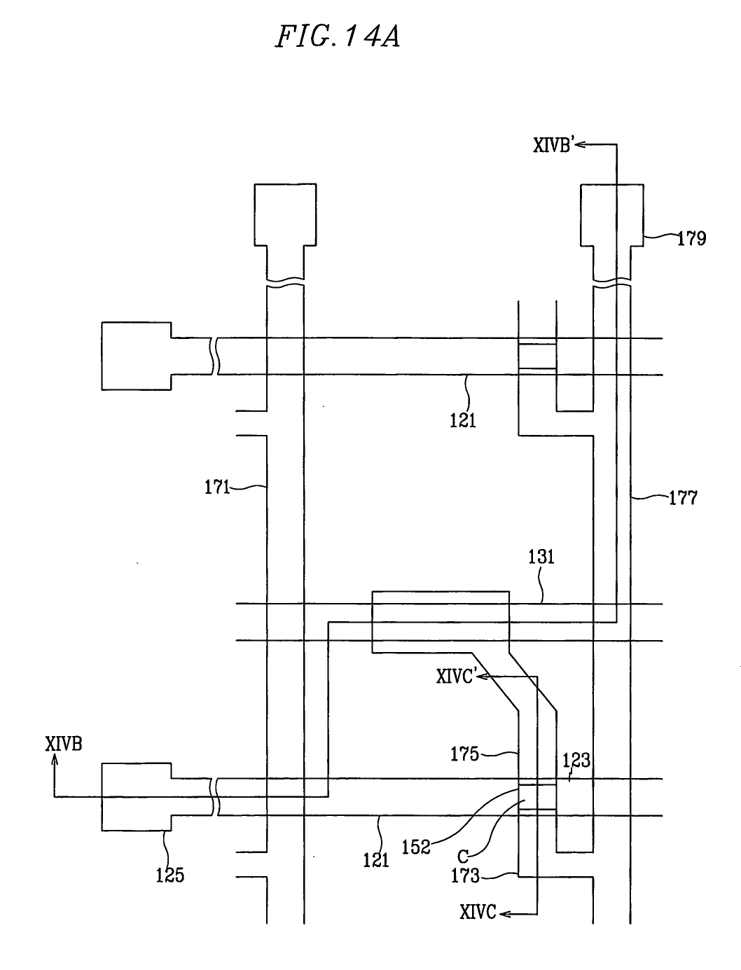

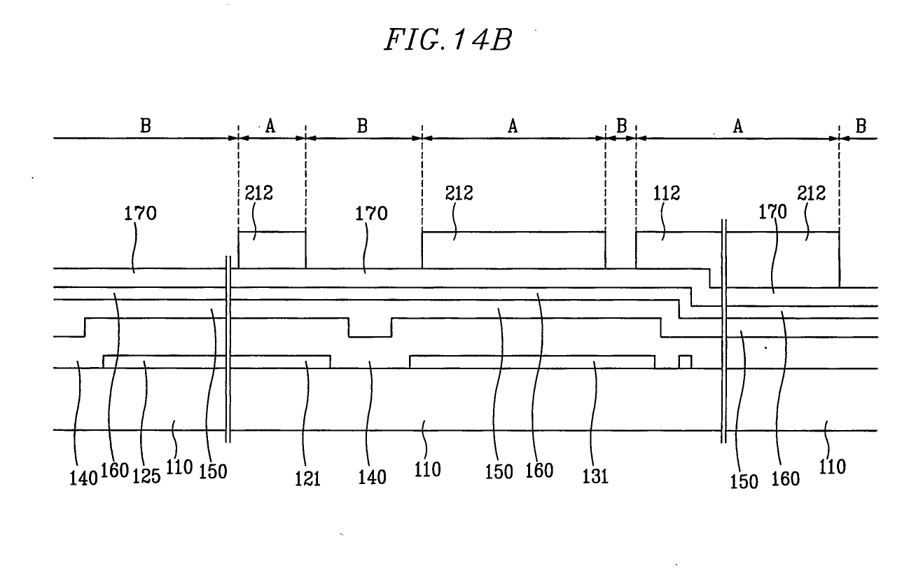

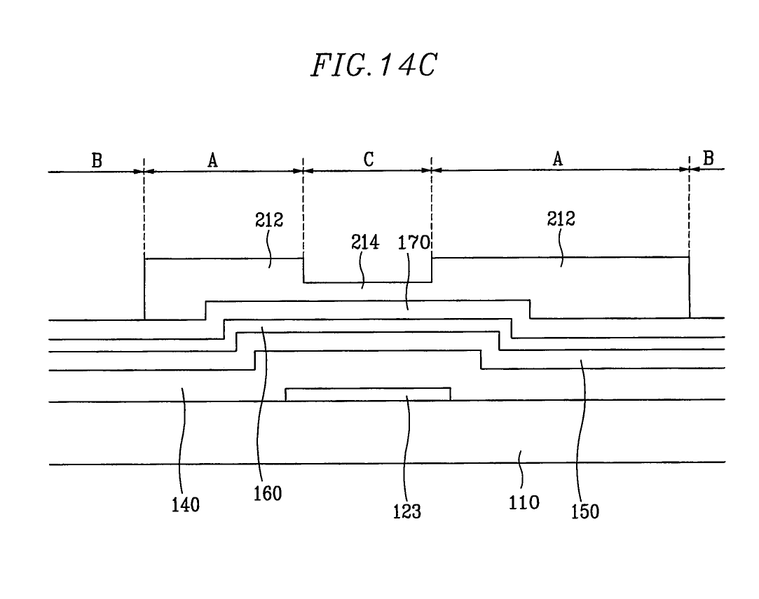

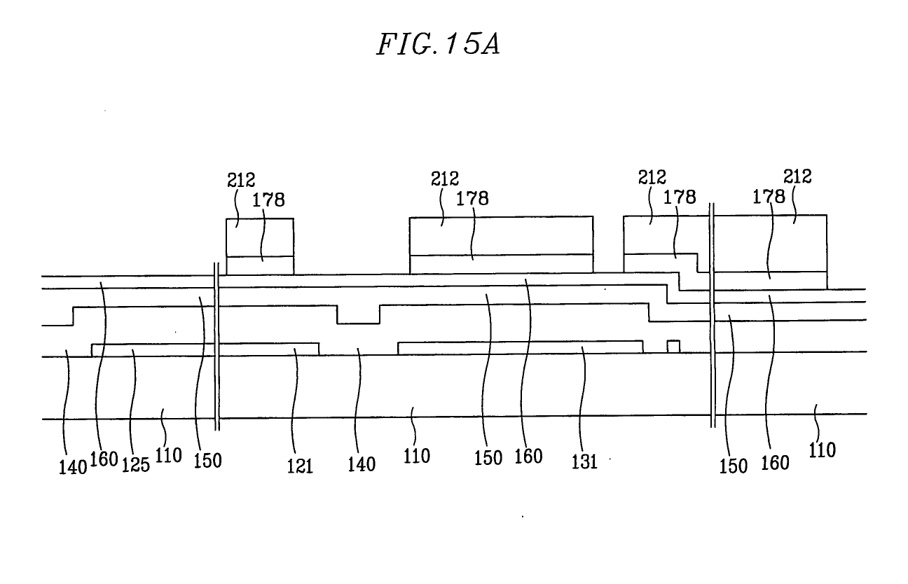

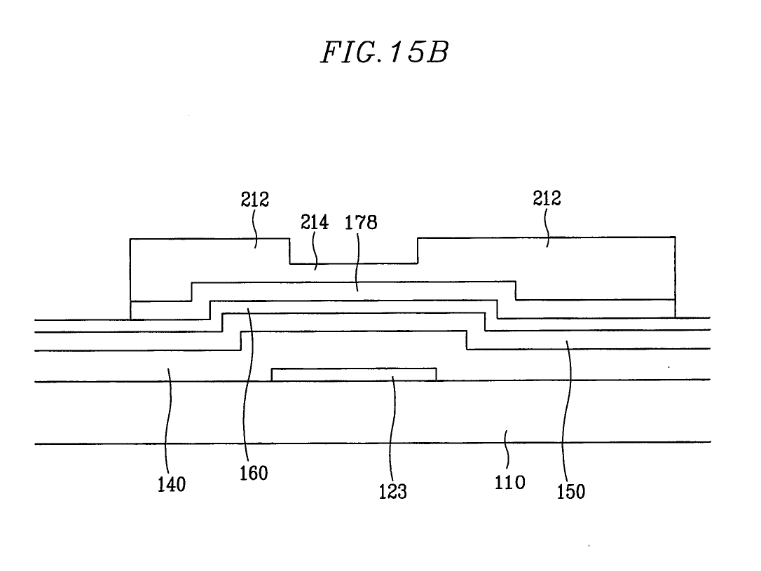

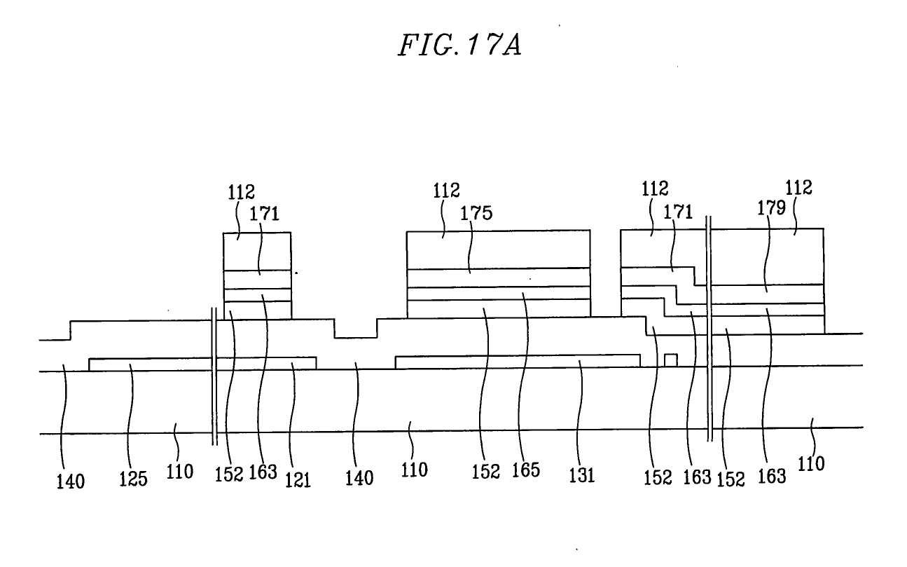

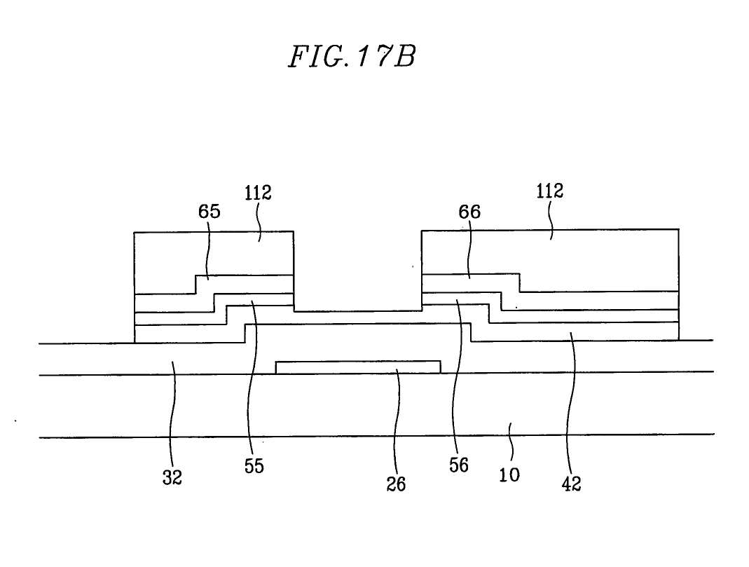

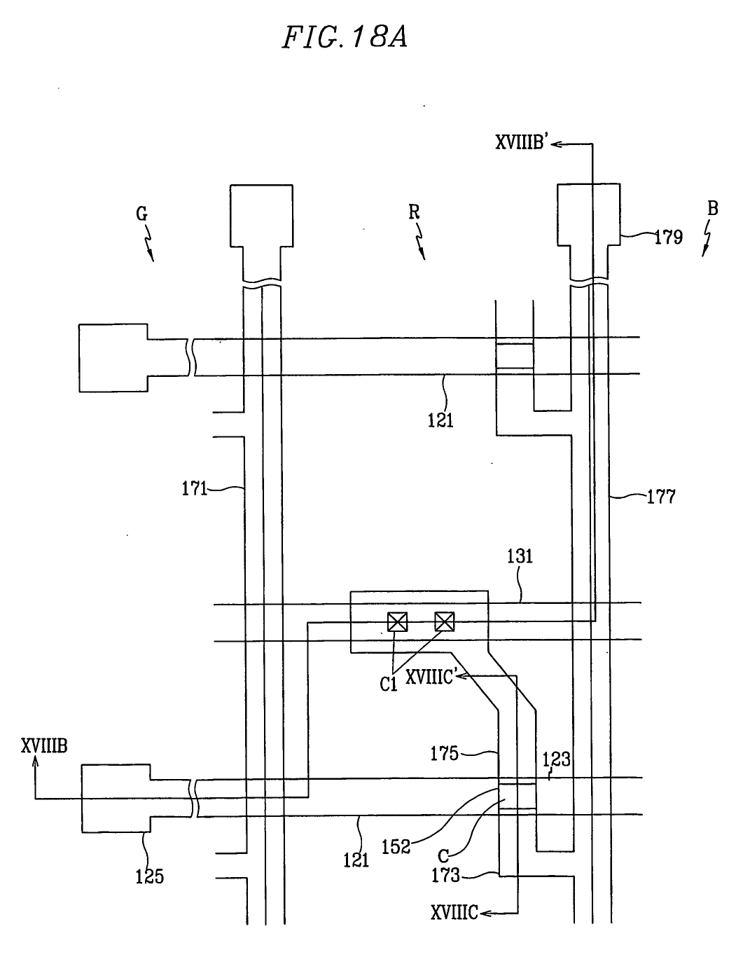

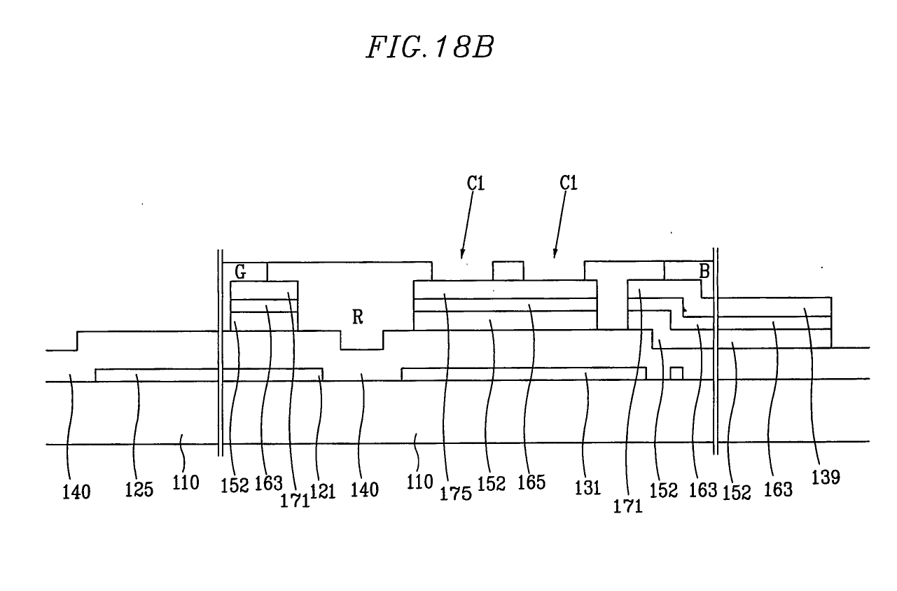

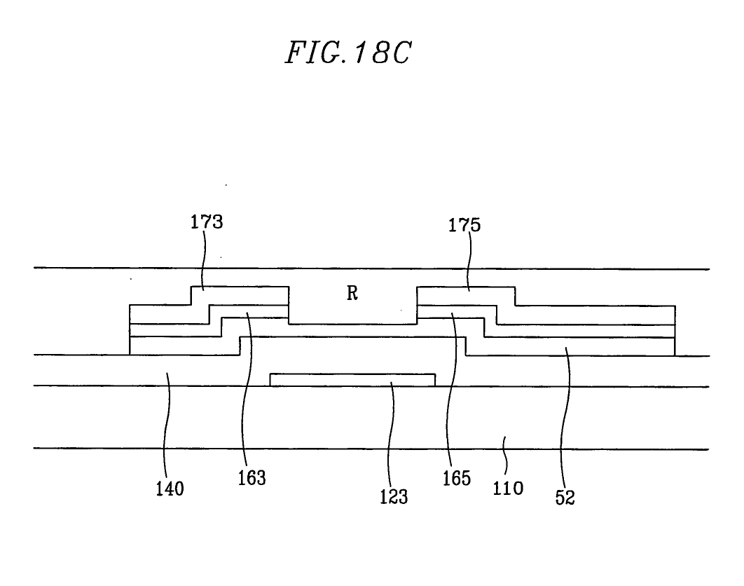

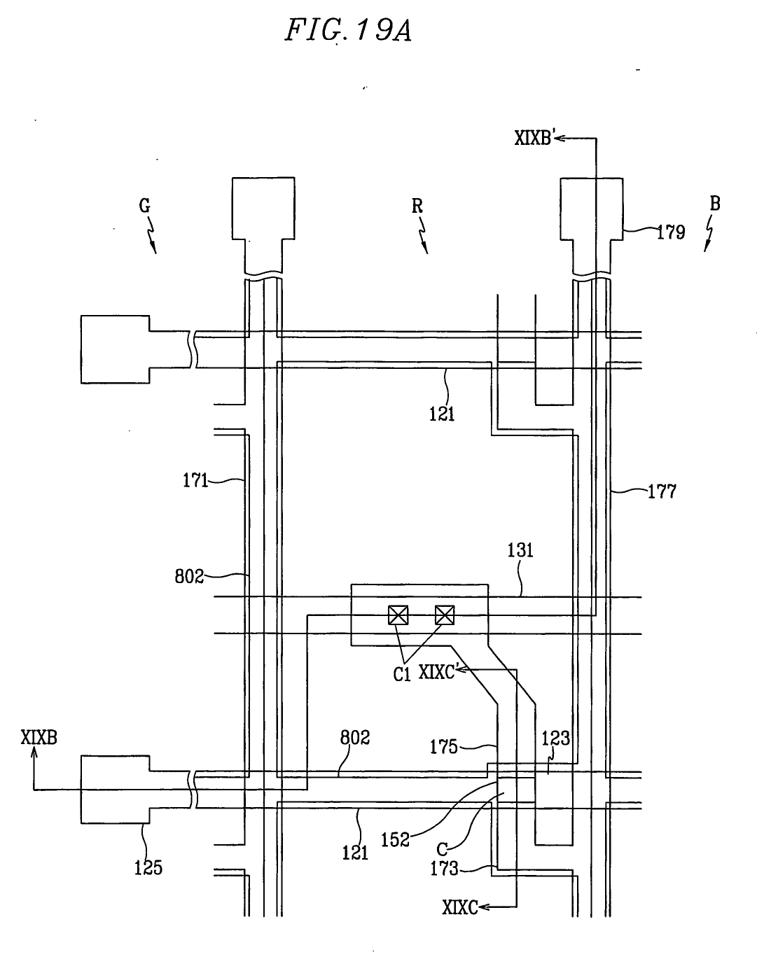

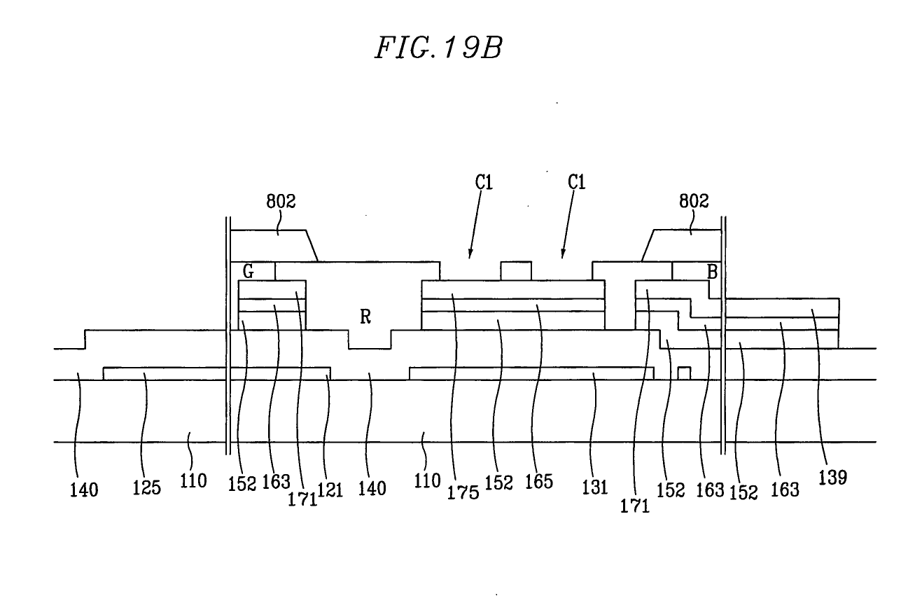

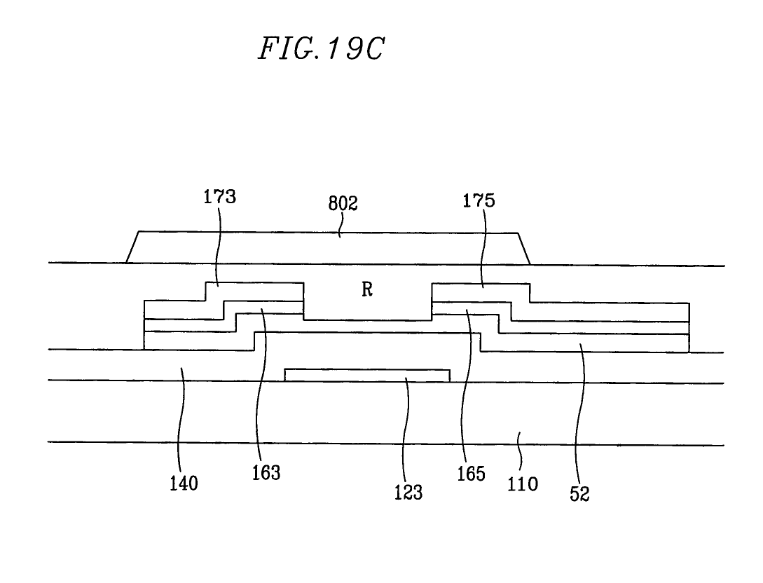

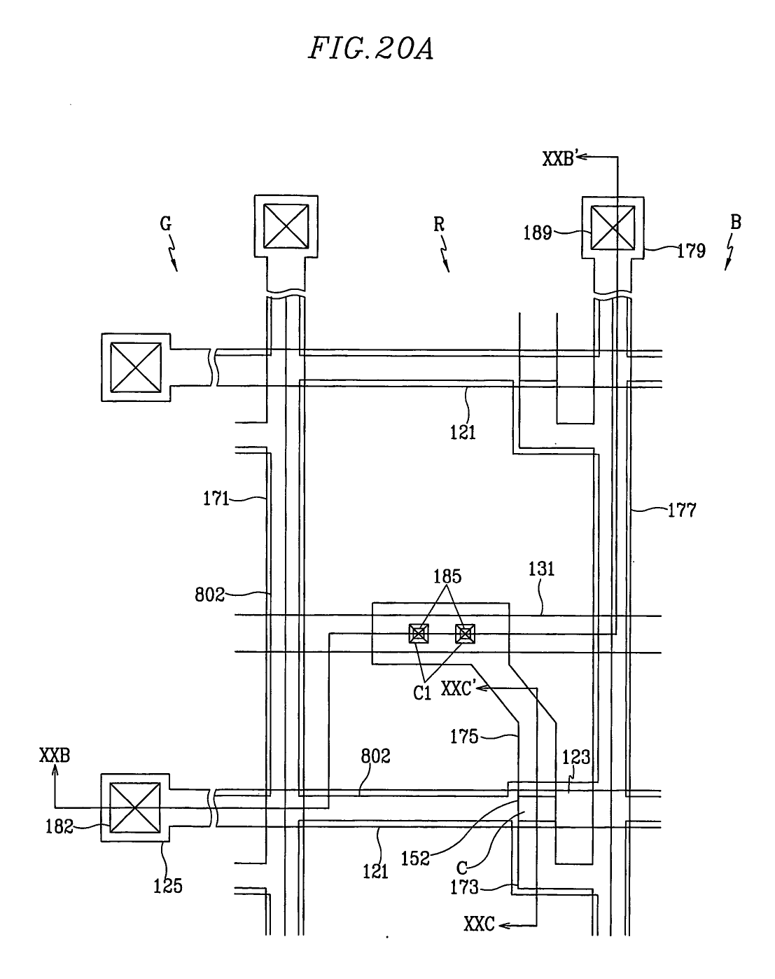

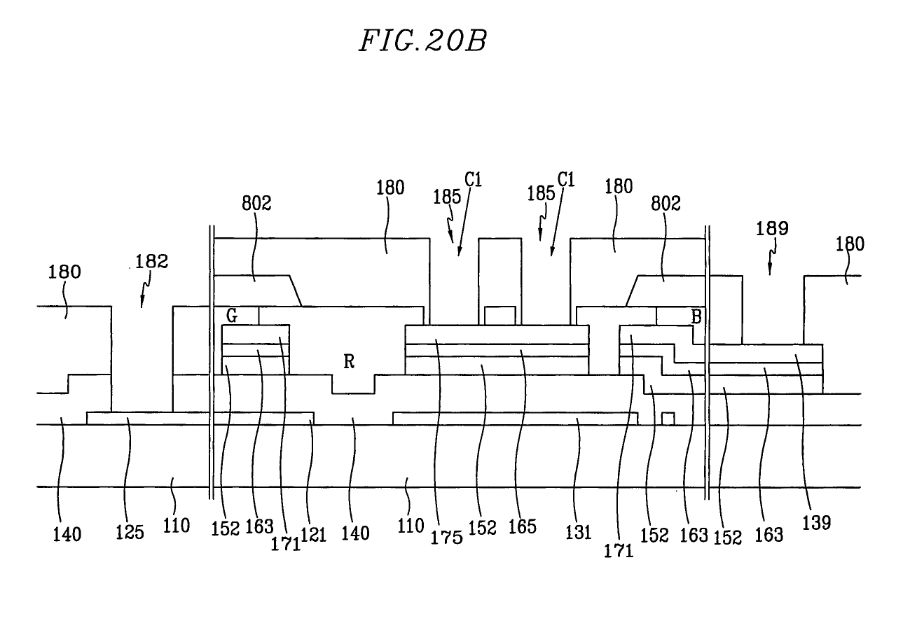

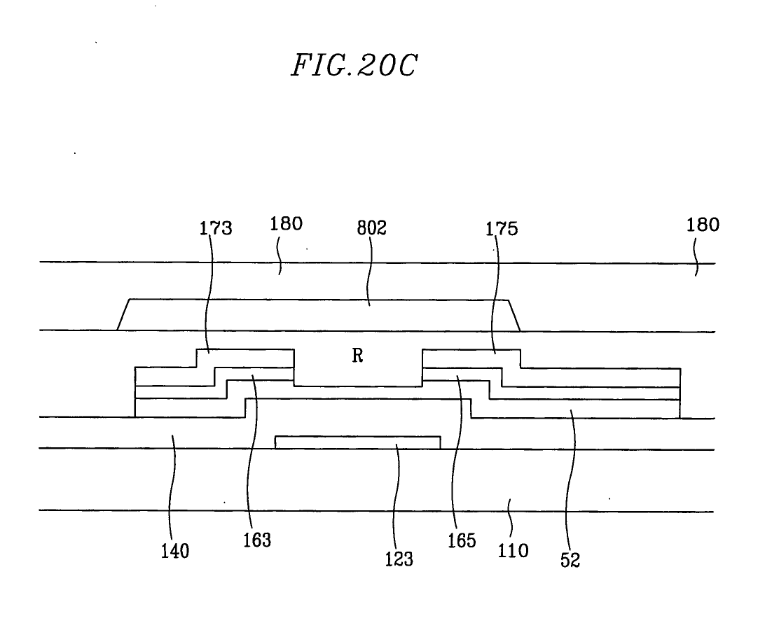

FIG. 12A is a layout view of a TFT array panel shown in FIGS. 9-11 in the first step of a manufacturing method thereof according to an embodiment of the present invention; FIGS. 12B and 12C are sectional views of the TFT array panel shown in FIG. 12A taken along the lines XIIB-XIIB′ and XIIC-XIIC′, respectively; FIGS. 13A and 13B are sectional views of the TFT array panel shown in FIG. 12A taken along the lines XIIB-XIIB′ and XIIC-XIIC′, respectively, illustrate the step following the step shown in FIGS. 12B and 12C; FIG. 14A is a layout view of the TFT array panel in the step following the step shown in FIGS. 13A and 13B; FIGS. 14B and 14C are sectional views of the TFT array panel shown in FIG. 14A taken along the lines XIVB-XIVB′ and XIVC-XIVC′, respectively; FIGS. 15A, 16A and 17A and FIGS. 15B, 16B and 17B are respective sectional views of the TFT array panel shown in FIG. 14A taken along the lines XIVB-XIVB′ and XIVC-XIVC′, respectively, and illustrate the steps following the step shown in FIGS. 14B and 14C; FIG. 18A is a layout view of a TFT array panel in the step following the step shown in FIGS. 17A and 17B; FIGS. 18B and 18C are sectional views of the TFT array panel shown in FIG. 19A taken along the lines XVIIIB-XVIIIB′ and XVIIIC-XVIIIC′, respectively; FIG. 19A is a layout view of a TFT array panel in the step following the step shown in FIGS. 18A and 18B; FIGS. 19B and 19C are sectional views of the TFT array panel shown in FIG. 19A taken along the lines XIXB-XIXB′ and XIXC-XIXC′, respectively; and FIG. 20A is a layout view of a TFT array panel in the step following the step shown in FIGS. 19A-19C; FIGS. 20B and 20C are sectional views of the TFT array panel shown in FIG. 20A taken along the lines XXB-XXB′ and XXC-XXC′, respectively.

Referring to FIGS. 12A-12C, a plurality of gate lines 121 including a plurality of gate electrodes 123 and a plurality of storage electrode lines 131 are formed on a substrate 110 by sputtering and photo etching. The gate lines 121 and the storage electrode lines 131 have a thickness of about 1,000-3,000 ?.

As shown in FIGS. 13A and 13B, a gate insulating layer 140, an intrinsic a-Si layer 150, and an extrinsic a-Si layer 160 are sequentially deposited by CVD such that the layers 140, 150 and 160 bear thickness of about 1,500-5,000 ?, about 500-2,000 ? and about 300-600 ?, respectively. A conductive layer 170 having a thickness of about 1,500-3,000 ? is deposited by sputtering, and a photoresist film 210 with the thickness of about 1-2 microns is coated on the conductive layer 170.

The photoresist film 210 is exposed to light through an exposure mask (not shown), and developed such that the developed photoresist has a position dependent thickness. The photoresist shown in FIGS. 14B and 14C includes a plurality of first to third portions with decreased thickness. The first portions located on wire areas A and the second portions located on channel areas C are indicated by reference numerals 212 and 214, respectively, and no reference numeral is assigned to the third portions located on remaining areas B since they have substantially zero thickness to expose underlying portions of the conductive layer 170. The thickness ratio of the second portions 214 to the first portions 212 is adjusted depending upon the process conditions in the subsequent process steps. It is preferable that the thickness of the second portions 214 is equal to or less than half of the thickness of the first portions 212, and in particular, equal to or less than 4,000 ?.

The different thickness of the photoresist 212 and 214 enables to selectively etch the underlying layers when using suitable process conditions. Therefore, a plurality of data lines 171 including a plurality of source electrodes 173 and a plurality of drain electrodes 175 as well as a plurality of ohmic contact stripes 163, a plurality of ohmic contact islands 165 and a plurality of semiconductor stripes 152 are obtained by a series of etching steps.

For descriptive purpose, portions of the conductive layer 170, the extrinsic a-Si layer 160, and the intrinsic a-Si layer 150 on the wire areas A are called first portions, portions of the conductive layer 170, the extrinsic a-Si layer 160, and the intrinsic a-Si layer 150 on the channel areas C are called second portions, and portions of the conductive layer 170, the extrinsic a-Si layer 160, and the intrinsic a-Si layer 150 on the remaining areas B are called third portions.

An exemplary sequence of forming such a structure is as follows:

(1) Removal of third portions of the conductive layer 170,- the extrinsic a-Si layer 160 and the intrinsic a-Si layer 150 on the wire areas A;

(2) Removal of the second portions 214 of the photoresist;

(3) Removal of the second portions of the conductive layer 170 and the extrinsic a-Si layer 160 on the channel areas C; and

(4) Removal of the first portions 212 of the photoresist.

Another exemplary sequence is as follows:

(1) Removal of the third portions of the conductive layer 170;

(2) Removal of the second portions 214 of the photoresist;

(3) Removal of the third portions of the extrinsic a-Si layer 160 and the intrinsic a-Si layer 150;

(4) Removal of the second portions of the conductive layer 170;

(5) Removal of the first portions 212 of the photoresist; and

(6) Removal of the second portions of the extrinsic a-Si layer 160.

The first example is described in detail.

As shown in FIGS. 15A and 15B, the exposed third portions of the conductive layer 170 on the remaining areas B are removed to expose the underlying third portions of the extrinsic a-Si layer 160. An Al or Al alloy film can be etched by any of dry etching and wet etching, while a Cr film is preferably wet etched with an etchant of CeNHO₃ can be used.

Reference numeral 178 indicates remaining portions of the conductive layer 170 after etching. The dry etching may etch out the top portions of the photoresist 212 and 214.

Referring to FIGS. 16A and 16B, the third portions of the extrinsic a-Si layer 160 and of the intrinsic a-Si layer 150 on the areas B are removed preferably by dry etching and the second portions 214 of the photoresist are removed to expose the second portions of the conductors 178. The removal of the second portions 214 of the photoresist are performed either simultaneously with or independent from the removal of the third portions of the extrinsic a-Si layer 160 and of the intrinsic a-Si layer 150. Residue of the second portions 214 of the photoresist remained on the channel areas C is removed by ashing.

The semiconductor stripes 152 are completed in this step, and reference numeral 168 indicates remaining portions of the extrinsic a-Si layer 160 after etching, which are called ‘extrinsic semiconductor stripes.’

As shown in FIGS. 17A and 17B, the second portions of the conductors 178 and the extrinsic a-Si stripes 168 on the channel areas C as well as the first portion 212 of the photoresist are removed.

As shown in FIG. 17B, top portions of the projections of the intrinsic semiconductor stripes 152 on the channel areas C may be removed to cause thickness reduction, and the first portions 212 of the photoresist are etched to a predetermined thickness.

In this way, each conductor 178 is divided into a data line 171 and a plurality of drain electrodes 175 to be completed, and each extrinsic semiconductor stripe 168 is divided into an ohmic contact stripe 163 and a plurality of ohmic contact islands 165 to be completed.

Referring to FIGS. 18A and 18B, photosensitive organic films respectively containing red, green, and blue pigments are coated and patterned by photolithography to form a plurality of color filters R, G and B having a plurality of openings C1 and C2 in a sequential manner.

Referring to FIGS. 19A and 19B, a photosensitive organic film containing black pigment is coated and patterned by photolithography to form a light blocking layer 802.

As shown in FIGS. 20A and 20B, after depositing a passivation layer 180, the passivation layer 180, the light blocking layer 802, and the gate insulating layer 140 are patterned by photo-etching to form a plurality of contact holes 182, 185 and 189. Referring to FIGS. 9-11, an ITO or IZO layer with a thickness in a range between about 500? and about 1,500? is sputtered and photo-etched to form a plurality of pixel electrodes 191 and a plurality of contact assistants 192 and 199.

Finally, an alignment layer 13 is coated on the passivation layer 180.

This embodiment simplifies the manufacturing process by forming the data lines 171 and the drain electrodes 175 as well as the ohmic contacts 163 and 165 and the semiconductor stripes 152 and using a single photolithography step.

Now, a method of manufacturing the common electrode panel shown in FIGS. 9-11 is described in detail.

A common electrode 270 preferably made of transparent conductive material such as ITO and IZO is formed on an insulating substrate 210. When required, the common electrode 270 is patterned to have a plurality of cutouts.

An organic insulating layer (not shown) having positive photosensitivity is coated on the common electrode 270 and exposed to light through a photo-mask having light blocking areas, translucent areas, and transparent areas. The organic layer is then developed to form a plurality of columnar spacers 350 facing the blocking areas of the mask and a plurality of protrusions 355 facing the translucent areas of the mask.

Finally, an alignment layer 23 is coated.

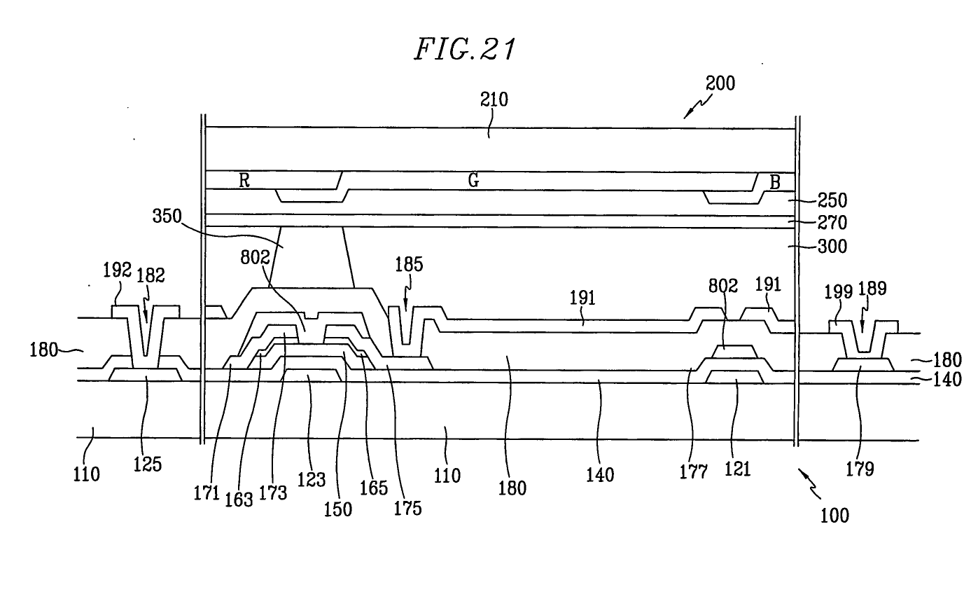

The protrusions 355 and the spacers 350 may be provided on the TFT array panel 100. An LCD according to another embodiment of the present invention will be described in detail with reference to FIG. 21.

FIG. 21 is a sectional view of an LCD according to another embodiment of the present invention.

Referring to FIG. 21, an LCD according to this embodiment also includes a TFT array panel 100, a common electrode panel 200, and a LC layer 300 interposed therebetween.

The layered structure of the TFT array panel according to this embodiment is almost the same as those shown in FIGS. 1 and 2.

Regarding the TFT array panel, a plurality of gate lines 121 including a plurality of gate electrodes 123 are formed on a substrate 110, and a gate insulating layer 140, a plurality of semiconductor stripes 152, and a plurality of ohmic contact stripes 163 and a plurality of ohmic contact islands 165 are sequentially formed thereon. A plurality of data lines 171 including a plurality of source electrodes 173 and a plurality of drain electrodes 175 are formed on the ohmic contacts 163 and 165, and a light blocking layer 802 and a passivation layer 180 are thereon. A plurality of contact holes 182, 185 and 189 are provided at the passivation layer 180 and the gate insulating layer 140, and a plurality of pixel electrodes 191 and a plurality of contact assistants 192 and 199 are formed on the passivation layer 180.

Different from the TFT array panel shown in FIGS. 9-11, there is no color filter on the TFT array panel 100

Concerning the common electrode panel 200, a common electrode 270, a plurality of color filters R, G and B, and an alignment layer 21 are sequentially formed on an insulating substrate 210.

Adjacent color filters R, G and B overlap each other.

As described above, the light blocking layer are provided on the TFT array panel such that they are removed from the common electrode panel. Accordingly, there is no need to consider the alignment between the panels and the width of the light blocking layer, the gate lines, and the data lines can be optimized to increase the aperture ratio.

While the present invention has been described in detail with reference to the preferred embodiments, those skilled in the art will appreciate that various modifications and substitutions can be made thereto without departing from the spirit and scope of the present invention as set forth in the appended claims.

1. A thin film transistor array panel comprising:
a gate line formed on an insulating substrate including a gate electrode;
a gate insulating layer on the gate line;
a semiconductor layer on the gate insulating layer;
a data line formed on the gate insulating layer and including a source electrode;
a drain electrode formed at least in part on the semiconductor layer;
a color filter formed on the data line and the drain electrode and having a first opening exposing the drain electrode at least in part;
a light blocking layer formed on the color filter;
a passivation layer formed on the color filter and the light blocking layer and having a contact hole exposing the drain electrode through the first opening of the color filter;
a pixel electrode formed on the passivation layer and contacting the drain electrode through the contact hole; and
a spacer formed on the passivation layer and disposed opposite the light blocking layer.

2. The thin film transistor array panel of claim 1, wherein the light blocking layer comprises organic material including black pigment.

3. The thin film transistor array panel of claim 1, wherein the spacer comprises organic material.

4. The thin film transistor array panel of claim 1, further comprising a storage conductor firmed on the gate insulating layer, overlapping the gate line, and electrically connected to the pixel electrode.

5. The thin film transistor array panel of claim 4, wherein the color filter has a second opening exposing the storage conductor at least in part and the passivation layer further has a second contact hole exposing the storage conductor at least in part through the second opening for connection between the storage conductor and the pixel electrode.

6. The thin film transistor array panel of claim 1, further comprising a storage electrode formed under the gate insulating layer and overlapping the pixel electrode.

7. The thin film transistor array panel of claim 6, further comprising a storage conductor firmed on the gate insulating layer, overlapping the storage electrode, and electrically connected to the pixel electrode.

8. The thin film transistor array panel of claim 7, wherein the color filter has a second opening exposing the storage conductor at least in part and the passivation layer further has a second contact hole exposing the storage conductor at least in part through the second opening for connection between the storage conductor and the pixel electrode.

9. The thin film transistor array panel of claim 1, wherein the passivation layer comprises acrylic material or a chemical vapor deposition film having a dielectric constant smaller than 4.0.

10. The thin film transistor array panel of claim 1, wherein the semiconductor layer has substantially the same planar shape as the data lines and the drain electrodes except for a portion between the source electrode and the drain electrode.

11. A liquid crystal display comprising:
a first panel including a gate line, a data line, a thin film transistor connected to the gate line and the data line, a pixel electrode connected to the thin film transistor, and a light blocking layer including organic material and black pigment;
a second panel facing the first panel and including a common electrode; and
a spacer disposed between the first panel and the second panel to form a gap therebetween and overlapping the light blocking layer.

12. The liquid crystal display of claim 11, further comprising a color filter formed on the first panel and having an opening exposing the drain electrode at least in part.

13. The liquid crystal display of claim 11, further comprising a protrusion formed on at least one of the first and the second panels, having a height smaller than the spacer, and having a slanted lateral surface.
